(19) United States
(12) Patent Application Publication
(10) Pub. No.: US 2007/0198741 A1
(43) Pub. Date: Aug. 23, 2007

(54) Accessing information

(75) Inventors: Bryan Duffy, Hertfordshire (GB); Matthew Norbury, Berkshire (GB); Matthew Gregory, Wiltshire (GB); Suman Sarker, London (GB); Francisco Hernandez, London (GB); Kingsley Duffy, London (GB); Terry Webb, Berkshire (GB); John Taylor, Surrey (GB); Nikunj Naik, Berkshire (GB); George Krause, Reading (GB); Jacob Kemsley, Alaigne (FR)

Correspondence Address: SCHWEGMAN, LUNDBERG, WOESSNER & KLUTH, P.A., P.O. BOX 2938, MINNEAPOLIS, MN, 55402, US

(73) Assignees: Instant Access Technologies Limited; Instant Access Technologies Limited; Instant Access Technologies Limited

(21) Appl. No.: 11/430,489

(22) Filed: May 8, 2006

(30) Foreign Application Priority Data
Feb. 21, 2006 (GB) 0603463.1

(51) Int. Cl. G06F 15/16

(52) U.S. Cl. 709/245

(57) ABSTRACT

The present invention relates to a method of providing direct access to webpages of an internet website, of the storage of the links to webpages, and to the evaluation of webpages. The present invention also relates to a mobile device. Methods and apparatus both fall within the scope of the invention. In particular, the present invention relates to systems, methods, apparatus and a software solution for providing internet users with a more rapid access to web pages within an internet website by providing users with their own searchable Personal Internet Directory (PID). The directory is preferably tailored to the preferences of individual users or classes of user and is searchable by the user via cached entries local to the user.

### CLAIM OF PRIORITY

The present patent application claims the priority benefit of the filing date of United Kingdom Patent Application No. 0603463.1 filed Feb. 21, 2006, the entire content of which is incorporated herein by reference.

### FIELD OF THE INVENTION

The present invention relates to a method of providing direct access to webpages of an internet website, of the storage of the links to webpages, and to the evaluation of webpages. The present invention also relates to a mobile device. Methods and apparatus both fall within the scope of the invention. In particular, the present invention relates to systems, methods, apparatus and a software solution for providing internet users with a more rapid access to web pages within an internet website by providing users with their own searchable Personal Internet Directory (PID). The directory is preferably tailored to the preferences of individual users or classes of user and is searchable by the user via cached entries local to the user.

### BACKGROUND TO THE INVENTION

The Internet has perhaps become the most widely used source of information, in its broadest sense, and entertainment available to its users. Vast repositories of information, opinion, opportunity, entertainment etc are available at the touch of a button or at the click of a mouse.

Users are enabled, according to their preferred operating system, internet browser, and/or Internet Service Provider (ISP) to create their own list of “favourite” websites. These can include links to website home pages, from which the user can navigate to preferred pages. For example, a user wishing to purchase goods over the internet can, in the first instance, visit a supplier's website via its home page. Access to that supplier's goods or services can be via a known website address or by use of any one of a number of commercially available “search engines” or dedicated service providers, which provide links to websites. The Uniform Resource Locater (URL) to the webpage of interest may then be “bookmarked” and saved within a list of favourites for future reference.

This is normally an adequate system, offering the user the opportunity to access preferred websites/web pages without the need to repeat the original navigation that was necessary to reach the desired page. However, it still requires the user to carry out research, e.g. using a commercial search engine, first to arrive at a suitable or relevant website and then to navigate to the page(s) of interest. Search engines can be useful in narrowing options from a vast arena of unknown sites but they can also be frustrating as a result of the large, often unmanageable, numbers of irrelevant results that they produce and their inherent inability to discriminate between quality and other sites. For example large search engines search over 8 billion sites.

A comparatively recent arrival on the scene is yahoo's “myweb”, a tool providing a way to save, share, and organize any page that the user may want on the Web. The user can save all the sites of interest then re-find them, organize them, and share them with whomever he wants. The “myweb” tool allows the user to search his list of saved URLs, and/or webpages, for the information he is looking for. The list of URLs, and or webpages, may include saved information from publicly accessible lists or other known users.

All of these options require the user to carry out his own navigation to websites that might possibly be relevant. There exists, therefore, a need for a new approach to accessing desired webpages on the internet, in which a trusted supplier vets websites and offers to users a directory of categories/classes of goods and services that are personal to the user. The present invention aims to provide such a new approach.

### SUMMARY OF THE INVENTION

The invention provides a method for providing direct access to a webpage of an internet website, the method comprising the steps of creating a structured directory of deep links, the deep links grouped according to a plurality of predetermined categories, each deep link representing an address of a specific webpage within a website corresponding to at least one of said predetermined categories; whereby a user can select a deep link from a chosen category and can activate said selected deep link to gain direct access to the webpage directly without navigating through the website from a home page to the webpage.

In a further aspect, the invention provides a method for providing direct access to a webpage of an internet website, the method comprising the steps of creating a structured directory of deep links, the deep links grouped according to a plurality of predetermined categories, each deep link representing an address of a specific webpage within a website; storing the directory of deep links in a memory local to a user; whereby a user can activate said selected deep link to gain direct access to the webpage directly without navigating through the website from a home page to the webpage.

In a further aspect, the invention provides a method for providing direct access to a webpage of an internet website, the method comprising the steps of creating a structured directory of links, each link representing an address of a webpage; storing the directory of links in a memory local to a user and remotely from the user; and storing user data in the local memory and the same data remotely from the user; wherein the user data includes a directory of further links that are specific to that user and are not shared with other users.

In a further aspect, the invention provides a method for directly accessing a webpage of an internet website, the method comprising the steps of creating a structured directory of deep links, the deep links grouped according to a plurality of predetermined categories, each deep link representing an address of a specific webpage within a website corresponding to at least one of said predetermined categories; storing the directory of deep links in a memory local to a user, said directory being searchable by a said user; and storing data relating to billing and/or tracking of usage by a said user.

In a further aspect, the invention provides a method for directly accessing a webpage of an internet website, the method comprising the steps of creating a structured directory of deep links, the deep links grouped according to a plurality of predetermined categories, each deep link representing an address of a specific webpage within a website corresponding to at least one of said predetermined categories; storing the directory of deep links in a memory local to a user, said directory being searchable by a said user; and wherein activation of said dedicated deep link by a user directly accesses predetermined special services in predetermined webpages of a website.

In a further aspect, the invention provides a method for providing, by a service provider, user access to webpages of internet websites, the method comprising the service provider establishing user links to a plurality of internet website pages in predetermined categories vetted by the service provider, and receiving from a user an inputted evaluation of at least one such website page using a dedicated one of said predetermined categories.

In a further aspect, the invention provides a method for enabling a mobile device, operating under the Mobile Information Device Profile (MIDP) protocol, to access internet web pages, comprising running in the device a midlet enabling user interaction with a screen of a said mobile device and containing means operable to extract screen dimensions and control key codes from data relating to make and model of device, and means operable to cause said screen to operate always in full screen mode regardless of make and model of said device.

In a yet further aspect, the invention provides a programming interface for programming a mobile device, having a viewable screen, to operate particular software, the interface comprising a package of widget classes for providing a programmer with an interface between the particular software and the device.

In a still further aspect, the invention provides a method for providing direct access to a webpage of an internet website, the method comprising the steps of creating a structured directory of deep links, the deep links grouped according to a plurality of predetermined categories, each deep link representing an address of a specific webpage within a website corresponding to at least one of said predetermined categories; storing the directory of deep links in memory; the directory of deep links being such that a user can select a deep link from a chosen category and can activate said selected deep link to gain direct access to the webpage without navigating through the website from a home page to the webpage; and storing data relating to a said direct access at three levels, comprising a top level local cache in memory, a records cache and memory on a server.

The invention extends, separately, to any of the novel features herein both in a (central) server and in a (remote) device, and also in software to be loaded thereon. Hence, for example, there is also provided in a further aspect, an apparatus for providing direct access to a webpage of an internet website, the apparatus comprising a memory storage for storing a structured directory of deep links, the deep links grouped according to a plurality of predetermined categories, each deep link representing an address of a specific webpage within a website corresponding to at least one of said predetermined categories and means for enabling a mobile device to store at least some of the deep links.

In a further aspect, the invention provides a method for providing, by a service provider, user access to internet webpages, the method comprising the service provider establishing user links to a plurality of internet website pages in predetermined categories vetted by the service provider; establishing a session for accessing said vetted website pages; and invoicing a fee to the user only once per session in which said vetted website pages are accessed.

In a further aspect, the invention provides a method for providing direct access to a webpage of an internet website, the method comprising the steps of:

creating a structured directory of deep links, the deep links grouped according to a plurality of predetermined categories, each deep link representing a specific address of a webpage within a website corresponding to at least one of said predetermined categories;

storing the directory of deep links in a memory local to a user;

whereby a user can select a deep link from a chosen category and can activate said selected deep link to gain direct access to the webpage directly without always having to navigate through the website from a home page to the webpage.

The method may further comprise updating the structured directory from a source remote from the user in an automated systematic cycle.

The method may further comprise automatically initiating said updating step when a user initiates an internet connection and/or accesses the structured directory.

The source may be a remote server.

The method may further comprise the step of providing a dedicated category containing a dedicated deep link to at least one predetermined page of a predetermined partner website offering special services, whereby activation of said dedicated deep link directly accesses predetermined special services in predetermined pages other than a home page of said partner website.

The method may further comprise the step of providing a dedicated category containing a dedicated link to a private home page of a predetermined partner website offering special services, whereby activation of said dedicated link directly accesses said private home page of said predetermined partner website; and navigating to at least one webpage within the partner website other than the private home page within the partner website, said private home page only being accessible to a user via the dedicated link.

The method may further comprise placing at highest priority a deep link that was the first deep link selected in a previous selection within the same category.

The method may further comprise providing said categories of predetermined websites according to the geographical location of a user.

The method may further comprise storing said directory in said memory as a searchable tree structure in which data is stored on the basis of a linked parent/child relationship.

In a further aspect, the invention comprises a method for directly accessing a webpage of an internet website, the method comprising the steps of:

creating a structured directory of deep links, the deep links grouped according to a plurality of predetermined categories, each deep link representing a specific address of a webpage within a website corresponding to at least one of said predetermined categories;

storing the directory of deep links in a memory local to a user;

selecting a category from said plurality of predetermined categories;

selecting a deep link within said selected category; and

activating the selected deep link to access the webpage directly, without navigating through the website from a home page to the webpage;

further comprising storing data relating to a said user, data relating to a partner offering special services on a partner website accessible via a dedicated deep link, and data relating to billing and tracking of usage by a said user, said data being stored in respective storage areas at a server remote from a user.

In a further aspect, the invention provides a method for directly accessing a webpage of an internet website, the method comprising the steps of:

creating a structured directory of deep links, the deep links grouped according to a plurality of predetermined categories, each deep link representing a specific address of a webpage within a website corresponding to at least one of said predetermined categories;

storing the directory of deep links in a memory local to a user, said directory being searchable by a said user;

further comprising storing data relating to billing and tracking of usage by a said user.

The method may further comprise storing said tracking and billing data in a storage area at a server remote from a said user.

In another aspect, the invention comprises a system for providing direct access to a webpage of an internet website other than a home page, the system comprising:

memory caching means local to a user and containing a structured directory of deep links, the deep links grouped according to a plurality of predetermined categories, each deep link representing a specific address of a webpage within a website corresponding to at least one of said predetermined categories;

first user-operable means to select a desired category;

second user-operable means to select a deep link within said selected category;

first means adapted to update the categories; and second means adapted to update the deep links;

wherein said first and second means are located remote from a user.

In a yet further aspect, the invention comprises a system for providing direct access to a webpage of an internet website other than a home page, the system comprising:

memory caching means local to a user and containing a dedicated deep link to at least one predetermined page of a predetermined partner website offering special services;

whereby activation of said dedicated deep link by a user directly accesses predetermined special services in predetermined webpages of said partner website.

Preferably, said memory caching means contains a plurality of deep links grouped in a directory according to a plurality of predetermined categories, each deep link representing a specific address of a webpage within a website corresponding to at least one of said predetermined categories, and wherein said dedicated deep link is contained within a category of deep links corresponding to said partner website.

Preferably, said directory includes a category dedicated to said special services, whereby a user may access directly said special services without navigating from a home page of said partner website.

Preferably, said special services are the same as those accessible by navigating from said home page of said partner website.

In a further aspect, the invention comprises a system for providing direct access to a specific webpage of an internet website, the method comprising:

first memory local to a user and containing a structured directory of deep links, the deep links grouped according to a plurality of predetermined categories, each deep link representing a specific address of a webpage within a website corresponding to at least one of said predetermined categories, said directory being searchable by a said user; and

second memory storing data relating to billing and tracking of usage by a said user.

Preferably, said second memory is located remote from a said user. The second memory may be located in a server containing data relating to the user.

In a further aspect, the invention comprises a system for providing direct access to a predetermined specific webpage of an internet website, the system comprising:

memory caching means local to a user and containing a dedicated deep link to at least one predetermined page of a predetermined partner website offering special services; and

memory means for storing data relating to accesses to said partner website by a user; further comprising:

a first storage location of said memory storing data relating to said partner;

a second storage location of said memory storing data relating to a user; and

a third storage location of said memory storing data relating to billing and tracking usage by the user.

Preferably, said memory means is located at a server remote from the user.

Preferably, said data relating to said user comprises a first set of data indicative of partner data available to the user, a second set of data comprises links to the partner website that have been stored locally to the user, and a third set of data relating to personal information on the user.

In a further aspect, the invention comprises a system for providing direct access to a specific webpage of an internet website, the system comprising:

memory caching means local to a user and containing a dedicated deep link to at least one predetermined page of a predetermined partner website offering special services; and

memory means for storing data relating to accesses to said partner website by a user; wherein:

a first storage location of said memory means holds data relating to said partner;

a second storage location of said memory means holds data relating to a user; and:

a server located remotely from the user:

merge/demerge means to upload user data from said memory caching means to said server and to upload data relating to the partner from said memory caching means to said server separately from one another.

In another aspect, the invention comprises a system for providing direct access to a webpage of an internet website, the system comprising:

memory caching means local to a user and containing a dedicated deep link to at least one predetermined page of a predetermined partner website offering special services; and

memory means for storing data relating to accesses to said partner website by a user; wherein:

a first storage location of said memory means holds data relating to said partner;

a second storage location of said memory means holds data relating to a user; and:

a server located remotely from the user:

merge/demerge means to download user data from said server to said memory caching means and to download data relating to the partner from server to said memory caching means separately from one another.

In another aspect, the invention comprises a computer-readable storage medium containing a set of instructions for accessing a user-selected one of a predetermined plurality of webpages of at least one internet website, the set of instructions comprising:

code for creating a structured directory of deep links, the deep links grouped according to a plurality of predetermined categories, each deep link representing an address of a said specific webpage within a website corresponding to at least one of said predetermined categories;

instructions for storing the directory of deep links in a memory local to a user;

instructions enabling a category from said plurality of predetermined categories to be selected by a user;

instructions enabling a deep link within said selected category to be selected by said user; and

instructions for enabling the selected deep link to access the webpage directly without navigating through the website from a home page of the website to the webpage.

In another aspect, the invention comprises a computer-readable storage medium containing a set of instructions for providing direct access to a user-selected webpage of an internet website, the set of instructions comprising:

instructions for caching, local to a user, a dedicated deep link to at least one predetermined page of a predetermined partner website offering special services; and

instructions enabling activation of said dedicated deep link to access directly said predetermined special services in at least one user-selected webpage other than a home page of said partner website.

In a further aspect, the invention comprises a computer-readable storage medium containing a set of instructions for providing direct access to a specific webpage of an internet website, the set of instructions comprising:

instructions for caching, local to a user, a dedicated deep link to at least one predetermined page of a predetermined partner website offering special services;

instructions for storing in memory data relating to accesses to said partner website by a said user;

instructions for storing in a first location of said memory data relating to said partner;

instructions for storing in a second location of said memory data relating to a user; and

instructions for storing in a third location of said memory data relating to billing and tracking usage by the user.

In a yet further aspect, the invention comprises a computer-readable storage medium containing a set of instructions for providing direct access to a specific webpage of an internet website, the set of instructions comprising:

instructions for storing in caching means local to a user, a dedicated deep link to at least one predetermined webpage of a predetermined partner website offering special services;

instructions for storing in memory data relating to accesses to said partner website by a said user;

instructions for storing in a first location of said memory data relating to said partner;

instructions for storing in a second location of said memory data relating to a user; and:

instructions for merging/demerging said data relating to said user and said data relating to said partner so as to separate said user data from said partner data when uploading user data to a server remote from the user and when downloading data from said server to said user.

In a further aspect, the invention comprises a computer-readable storage medium containing a set of instructions enabling a data processing system to access a webpage of a user-selectable website, the set of instructions comprising:

instructions for creating a structured directory of deep links, the deep links grouped according to a plurality of predetermined categories, each deep link representing an address of a said specific webpage within a website corresponding to at least one of said predetermined categories;

instructions for storing the directory of deep links in a memory local to a user;

instructions enabling user selection of a category from said plurality of predetermined categories;

instructions enabling user selection of a deep link within said selected desired category; and

instructions enabling the selected deep link to access the user-selected specific webpage of the website directly.

In a further aspect, the invention comprises a computer when programmed to carry out the steps of:

creating a structured directory of deep links, the deep links grouped according to a plurality of predetermined categories, each deep link representing an address of a specific webpage within a website corresponding to at least one of said predetermined categories;

storing the directory of deep links in a memory local to a user;

enabling a category to be selected by a user from said plurality of predetermined categories;

enabling a deep link within said selected desired category to be selected by said user; and

enabling the selected deep link to be activated by said user to access the webpage directly without navigating through the website from a home page to the user-selected webpage.

In another aspect, the invention comprises a computer-readable signal or carrier wave adapted to be propagated over the Internet between computers, said signal containing a set of instructions for accessing a user-selected one of a predetermined plurality of webpages of at least one internet website, the set of instructions comprising:

code for creating a structured directory of deep links, the deep links grouped according to a plurality of predetermined categories, each deep link representing address of a said specific webpage within a website corresponding to at least one of said predetermined categories;

instructions for storing the directory of deep links in a memory local to a user;

instructions enabling a category from said plurality of predetermined categories to be selected by a user;

instructions enabling a deep link within said selected category to be selected by said user; and

instructions for enabling the selected deep link to access the webpage directly without navigating through the website from a home page of the website to the webpage.

In a yet further aspect, the invention comprises a computer-readable signal or carrier wave adapted to be propagated over the Internet between computers, said signal containing a set of instructions for providing direct access to a user-selected webpage of an internet website, the set of instructions comprising:

instructions for caching, local to a user, a dedicated deep link to at least one predetermined page of a predetermined partner website offering special services; and

instructions enabling activation of said dedicated deep link to access directly said predetermined special services in at least one user-selected webpage other than a home page of said partner website.

In a further aspect, the invention comprises a computer-readable signal or carrier wave adapted to be propagated over the Internet between computers, said signal containing a set of instructions for providing direct access to a specific webpage of an internet website, the set of instructions comprising:

instructions for caching, local to a user, a dedicated deep link to at least one predetermined page of a predetermined partner website offering special services;

instructions for storing in memory data relating to accesses to said partner website by a said user;

instructions for storing in a first location of said memory data relating to said partner;

instructions for storing in a second location of said memory data relating to a user; and

instructions for storing in a third location of said memory data relating to billing and tracking usage by the user.

In a further aspect, the invention comprises a computer-readable signal or carrier wave adapted to be propagated over the Internet between computers, said signal containing a set of instructions for providing direct access to a specific webpage of an internet website, the set of instructions comprising:

instructions for storing in caching means local to a user, a dedicated deep link to at least one predetermined webpage of a predetermined partner website offering special services;

instructions for storing in memory data relating to accesses to said partner website by a said user;

instructions for storing in a first location of said memory data relating to said partner;

instructions for storing in a second location of said memory data relating to a user; and:

instructions for merging/demerging said data relating to said user and said data relating to said partner so as to separate said user data from said partner data when uploading user data to a server remote from the user and when downloading data from said server to said user.

In a further aspect, the invention comprises a computer-readable signal or carrier wave adapted to be propagated over the Internet between computers, said signal containing a set of instructions enabling a data processing system to access a webpage of a user-selectable website, the set of instructions comprising:

instructions for creating a structured directory of deep links, the deep links grouped according to a plurality of predetermined categories, each deep link representing an address of a said specific webpage within a website corresponding to at least one of said predetermined categories;

instructions for storing the directory of deep links in a memory local to a user;

instructions enabling user selection of a category from said plurality of predetermined categories;

instructions enabling user selection of a deep link within said selected desired category; and

instructions enabling the selected deep link to access the user-selected specific webpage of the website directly.

In a further aspect of the invention there is provided a system allowing direct access to a webpage of an internet website from a plurality of terminals, the system comprising:

memory local to a user and holding a structured directory of deep links, the deep links grouped according to a plurality of predetermined categories, each deep link representing an address of a specific webpage within a website corresponding to at least one of said predetermined categories;

selection means whereby a user can select a deep link from a chosen predetermined category and can activate said selected deep link to gain direct access to the webpage without navigating to the webpage from a home page; wherein:

said predetermined categories are predetermined in accordance with a user profile relating at least partly to a user's preferences, and wherein said profile is portable between said terminals, whereby the categories available to the user are determined by the user profile independently of the terminal used by the user to access the system.

In a further aspect of the invention said memory caching means contains a plurality of deep links grouped in a directory according to a plurality of predetermined categories, each deep link representing an address of a said specific webpage within a website corresponding to at least one of said predetermined categories, and wherein said dedicated deep link is contained within a category of deep links corresponding to said partner website.

The present invention extends to a server for implementing the aforsesaid methods at said remote location, apparatus local to said user for implementing the methods, a system incorporating the server and the apparatus, signals embodying the methods, and computer readable media and computer program products embodying the methods.

Personalised Internet Directory

According to a further aspect of the present invention, there is provided a method for providing direct access to a webpage of an internet website, the method comprising the steps of:

creating a structured directory of deep links, the deep links grouped according, to a plurality of predetermined categories, each deep link representing an address of a specific webpage within a website corresponding to at least one of said predetermined categories;

whereby a user can select a deep link from a chosen category and can activate said selected deep link to gain direct access to the webpage directly without navigating through the website from a home page to the webpage.

Preferably, the predetermined categories are dependent from wider classifications. Preferably, the method further comprises the step of storing the directory in said memory as a searchable tree structure in which data is stored on the basis of a linked parent/child relationship.

Suitably, the predetermined categories constitute a menu style directory. Preferably, the predetermined categories are selected from a larger collection of such categories. Preferably, only the predetermined categories are displayed. Preferably, the larger collection of such categories is displayed. Preferably, a dedicated category is created for internet search engines.

Preferably, the structured directory is searchable. Preferably, the structured directory is searchable alphanumerically. Preferably, a user can search on a look ahead basis. Preferably, when searching the top match is auto rendered within a display pane. Preferably, the structured directory is visible at the same time and on the same display as a preview pane. Preferably, a plurality of preview panes are displayed. Preferably, the preview pane displays a selected deep link. Preferably, the preview pane displays a webmail application. Preferably, the preview pane displays current affairs information. Preferably, the preview pane displays a VOIP application.

Preferably, a single user click enables access to the deep link. Preferably, the single user click enables such access from within any such predetermined category.

Preferably, the method further comprises modifying the directory of deep links via user input. Preferably, in the modifying step the user adds a favourite deep link. Preferably, in the modifying step the user deletes an existing user defined deep link. Preferably, in the modifying step the user hides an existing deep link.

Preferably, the predetermined categories are tailored to an individual user in dependence on user personal information. Preferably, such user personal information is at least one of age, gender, location and special interests.

Preferably, a “Favourites” list from an internet browser is imported into the structured directory of deep links. Preferably, the structured directory is searchable via a dedicated toolbar in an internet browser. Preferably, the structured directory of deep links is displayed as a menu within an internet browser. Preferably, the method further comprises displaying a home page from which the structured directory is accessed. Preferably, the home page is tailored according to user preference.

Preferably, the deep links are vetted with human intervention. Preferably, the deep links are updated with human intervention.

Preferably, the method further comprises the step of:

providing a dedicated category containing a dedicated deep link to at least one predetermined page of a predetermined partner website offering special services, whereby activation of the dedicated deep link directly accesses predetermined special services in predetermined pages other than a home page of the partner website.

Preferably, the method further comprises the step of:

providing a dedicated category containing a dedicated link to a private home page of a predetermined partner website offering special services, whereby activation of the dedicated link directly accesses the private home page of the predetermined partner website; and

navigating to at least one webpage within the partner website other than the private home page within the partner website, the private home page only being accessible to a user via the dedicated link.

Preferably, the deep links have an identifier to determine whether they can be viewed on a personal computer or a mobile device or both.

Local Caching of Deep Links

Preferably, the method further comprises storing the directory of deep links in a memory local to a user.

In a further aspect, the invention provides a method for directly accessing a webpage of an internet website, the method comprising the steps of:

creating a structured directory of deep links, the deep links grouped according to a plurality of predetermined categories, each deep link representing an address of a specific webpage within a website;

storing the directory of deep links in a memory local to a user; whereby a user can activate the selected deep link to gain direct access to the webpage directly without navigating through the website from a home page to the webpage.

Preferably, the method further comprises storing the directory of deep links remotely from the user. Preferably, deep links for a larger collection of categories are stored remotely from the user than are stored in the local memory, and the deep links for the categories stored in the local memory are selected from the larger collection of such categories. Preferably, the method further comprises the step of updating the structured directory from a source remote from the user. Preferably, the method further comprises the step of automatically initiating the updating step when a user selects a deep link. Preferably, the structured directory in the local memory is only updated from the remote source if and to the extent that its content is out of date. Preferably, the source is a remote server. Preferably, the source remote from the user updates the directories of deep links in memories local to other users.

Preferably, different local memories store directories that are different but have at least one deep link in common. Preferably, the at least one deep link in common is stored remotely from the users, at a central server.

Preferably, the method further comprises the step of:

prioritising deep links within each category on the basis of the popularity of all the deep links in that category.

Merging/Demerging

Preferably, the method further comprises storing user data in the local memory and the same data remotely from the user; wherein the user data includes a directory of further links that are specific to that user and are not shared with other users.

In a further aspect, the invention provides a method for providing direct access to a webpage of an internet website, the method comprising the steps of: creating a structured directory of links, each link representing an address of a webpage;

storing the directory of links in a memory local to a user and remotely from the user; and

storing user data in the local memory and the same data remotely from the user;

wherein the user data includes a directory of further links that are specific to that user and are not shared with other users.

Preferably, the directory of links and the directory of further links specific to a user are stored logically separately from one another at the location remote from the user. Preferably, the directory of links and the directory of further links specific to a user are displayed as a single directory to that user.

Preferably, the directory of links stored at the location remote from the user is updated when a link is identified as having changed.

Preferably, the user data further includes at least one of user profile, a list of user folders (such as categories or classifications), a list of user defined links, and a list of those categories of links stored remotely from the user that are also stored in the local memory. Preferably, the user data in the local memory is updated to the store remote from the user when the link between user and remote store is about to be broken.

Three Storage Areas—Partner, User and Tracking & Billing

Preferably, the method further comprises storing data relating to billing and/or tracking of usage by a user.

In a further aspect, the invention provides a method for directly accessing a webpage of an internet website, the method comprising the steps of:

creating a structured directory of deep links, the deep links grouped according to a plurality of predetermined categories, each deep link representing an address of a specific webpage within a website corresponding to at least one of the predetermined categories;

storing the directory of deep links in a memory local to a user, the directory being searchable by a user; and

storing data relating to billing and/or tracking of usage by a user.

Preferably, the method further comprises storing the tracking and/or billing data remotely from a user. Preferably, the remotely stored data is stored in a remote server.

Preferably, the remote server contains:—

a first storage location storing data relating to a partner website offering special services;

a second storage location storing data relating to the user; and

a third storage location storing data relating to billing and/or tracking usage by the user.

Preferably, the data relating to the user comprises a first set of data indicative of partner data available to the user, a second set of data comprising user defined links to websites that have been stored locally to the user, and a third set of data relating to the user's profile.

Preferably, the method further comprises computing from the billing data commission due from sales made using the directory of deep links.

Preferably, the method further comprises ranking webpages according to the tracked usage.

Special Offers Classification

Preferably, activation of a dedicated deep link by a user directly accesses predetermined special services in predetermined webpages other than a home page of a website.

In a further aspect, the invention provides a method for directly accessing a webpage of an internet website, the method comprising the steps of:

creating a structured directory of deep links, the deep links grouped according to a plurality of predetermined categories, each deep link representing an address of a specific webpage within a website corresponding to at least one of the predetermined categories;

storing the directory of deep links in a memory local to a user, the directory being searchable by a user; and

wherein activation of the dedicated deep link by a user directly accesses predetermined special services in predetermined webpages of a website.

Preferably, the directory includes a category dedicated to special services, whereby a user may access directly the special services without navigating from a home page of a website. Preferably, the special services are the same as those accessible by navigating from the home page of a website. Preferably, special offers are accessible to the user via two routes: firstly through the special offers classification, secondly through the classification that it would be normally be found in.

Same User Profile

Preferably, predetermined categories are predetermined in accordance with a user profile relating at least partly to a user's preferences, and wherein the profile is portable between different devices, whereby the categories available to the user are determined by the user profile independently of the terminal used by the user to access the system.

In a further aspect, the invention provides a method for providing direct access to a webpage of an internet website, the method comprising the steps of:

creating a structured directory of deep links, the deep links grouped according to a plurality of predetermined categories, each deep link representing an address of a specific webpage within a website corresponding to at least one of the predetermined categories;

selecting a deep link from a chosen predetermined category and activating the selected deep link to gain direct access to the specific webpage; and

predetermining the predetermined categories in accordance with a user profile relating at least partly to a user's preferences;

wherein the profile is portable between the terminals, whereby the categories available to the user are determined by the user profile independently of the terminal used by the user to access the system.

Blogs

In a yet further aspect, the invention provides a method for providing, by a service provider, user access to webpages of internet websites, the method comprising:

the service provider establishing user links to a plurality of internet website pages in predetermined categories vetted by the service provider, and

receiving from a user an inputted evaluation of at least one such website page using a dedicated one of the predetermined categories.

Preferably, the links are deep links. Preferably, the user may submit a link to be included within the predetermined categories. Preferably, a user inputted evaluation is received for a user link. Preferably, the user link is included within the predetermined categories when a predetermined number of positive evaluations are received for a user link. Preferably, the method further provides a dedicated webpage in one of the predetermined categories for the receipt of the user inputted evaluation. Preferably, the method further comprises the step of the service provider modifying the content of the predetermined categories in response to the user evaluation.

In a further aspect, the invention provides a method for providing direct access to webpages of internet websites, the method comprising the steps of:

creating a structured directory of deep links, the deep links grouped according to a plurality of predetermined categories, each deep link representing an address of a specific webpage within a website corresponding to at least one of the predetermined categories, whereby a user can select a deep link from a chosen category and can activate the selected deep link to gain direct access to the webpage without navigating through the website from a home page to the webpage; and

receiving from a user an inputted evaluation of at least one such website page using a dedicated one of the predetermined categories.

Preferably, the website is a website corresponding to an existing category included in the directory. Preferably, the website is a website under consideration for inclusion in the directory. Preferably, the website is added to the directory when it is rated sufficiently highly by users. Preferably, the evaluation is applied to a partner webpage or partner website offering special services to users. Preferably, the special services provide the user privileged access to information and/or special offers. Preferably, the evaluation comprises a score for each of a plurality of criteria. Preferably, the score comprises a score out of a maximum of five per category. Preferably, there are four categories. Preferably, the four categories comprise popularity, functionality, design, and content. Preferably, the method further comprises receiving a free text comment for appraisal by other users.

In a further aspect, the invention provides a computer when programmed to carry out the steps for:

providing, by a service provider, user access to pages of internet websites:

establishing by the service provider user links to a plurality of internet website pages in predetermined categories vetted by the service provider, and:

providing as one of the predetermined categories a page by which users may input an evaluation of a website.

In a further aspect, the invention provides a computer for providing direct access to webpages of internet websites, when programmed to carry out the steps of:

creating a structured directory of deep links, the deep links grouped according to a plurality of predetermined categories, each deep link representing an address of a specific webpage within a website corresponding to at least one of the predetermined categories;

enabling a category to be selected by a user from the plurality of predetermined categories;

enabling a deep link within the selected desired category to be selected by a user; and

enabling the selected deep link to be activated by a user to access a corresponding webpage directly without navigating through the website from a home page to the webpage; and

enabling a user to input an evaluation of a website using a dedicated one of the predetermined categories.

In a further aspect, the invention provides a computer-readable storage medium comprising a set of instructions for providing, by a service provider, user access to pages of internet websites, the instructions comprising:

code establishing, a directory of user links to internet website pages in predetermined categories vetted by the service provider; and

code enabling a user to input an evaluation of a website using a dedicated one of the predetermined categories.

In a further aspect, the invention provides a computer-readable signal or carrier wave adapted to be propagated over the Internet between computers, the signal containing a set of instructions for providing, by a service provider, user access to pages of internet websites, the instructions comprising:

code for establishing user links to internet website pages in predetermined categories vetted by the service provider, one of the predetermined categories comprising a page by which users may input an evaluation of a website.

Running Midlets Using ScreenProxy and HandsetCharacteristics Classes

In a yet further aspect, the invention provides a method for enabling a mobile device, operating under the Mobile Information Device Profile (MIDP) protocol, to access internet web pages, comprising running in the device a midlet enabling user interaction with a screen of a mobile device and containing means operable to extract screen dimensions and control key codes from data relating to make and model of device, and means operable to cause the screen to operate always in full screen mode regardless of make and model of the device.

Preferably, the midlet contains a class structure. Preferably, the class structure comprises a (HandsetCharacteristics) class, operable to extract screen dimensions and control key codes from data relating to make and model of device, and a (ScreenProxy) class operable to cause the screen to operate always in full screen mode regardless of make and model of the device.

In a further aspect, the invention provides a computer-readable storage medium containing a set of instructions permitting a data processing system to enable a mobile device operating under the Mobile Information Device Profile (MIDP) protocol, to access internet web pages, comprising instructions for running in the device a midlet enabling user interaction with a screen of a device and containing means operable to extract screen dimensions and control key codes from data relating to make and model of device, and means operable to cause the screen to operate always in full screen mode regardless of make and model of the device.

In a further aspect, the invention provides a device operating under the Mobile Information Device Profile (MIDP) protocol to access internet web pages, when programmed to carry out the steps of running in the device a midlet enabling user interaction with a screen of a device and containing means operable to extract screen dimensions and control key codes from data relating to make and model of device, and means operable to cause the screen to operate always in full screen mode regardless of make and model of the device.

Preferably, the device comprises a mobile computer. Preferably, the device comprises a mobile telephone.

UI Toolkit

In a further aspect, the invention provides a programming interface for programming a mobile device, having a viewable screen, to operate particular software, the interface comprising a package of widget classes for providing a programmer with an interface between the particular software and the device.

Preferably, the widget classes provide a graphical interface. Preferably, access to the widget classes is provided via a menu bar. Preferably, (programmer) access to the widget classes is provided via an application programming interface (API). Preferably, (user) access to the widget classes is provided via navigation keys provided on the mobile device.

Preferably, the package of widget classes includes:

a screen widget for painting the viewable screen; and

a screen proxy class for interfacing between the screen widget and the viewable screen to cause the viewable screen always to be operated in full screen mode.

Preferably, the method further comprises a handset characteristics class for providing a universal interface so that any device can access the software regardless of the make and model of the device.

Preferably, the method further comprises a means for retrieving from the handset characteristics class the dimensions of the viewable screen and relevant key codes for control keys of the device. Preferably, the method further comprises a means for defining the properties of the viewable screen display. Preferably, the properties include background colour and font size and type. Preferably, the programming interface further comprises a means for defining the position on the viewable screen where a feature is to be painted.

Preferably, the programming interface further comprises a text widget for enabling text to be displayed on the viewable screen at the maximum size that can be displayed in the relevant part of the viewable screen. Preferably, the programming interface further comprises a means for inputting text predictively.

In a further aspect, the invention provides a computer-readable storage medium containing a set of instructions for a programming interface for programming a mobile device having a viewable screen to operate particular software, the instructions comprising;

instructions for providing an interface between the programmer and the device, and

instructions comprising a package of widgets which provide a programmer with an interface between the particular software and the device.

Preferably, the instructions comprise;

instructions comprising a screen widget for painting the viewable screen; and

instructions comprising a screen proxy class for interfacing between the screen widget and the viewable screen to cause the viewable screen always to be operated in full screen mode.

Three-Level Storage

In a yet further aspect, the invention provides a method for providing direct access to a webpage of an internet website, the method comprising the steps of:

creating a structured directory of deep links, the deep links grouped according to a plurality of predetermined categories, each deep link representing an address of a specific webpage within a website corresponding to at least one of the predetermined categories;

storing the directory of deep links in memory,

the directory of deep links being such that a user can select a deep link from a chosen category and can activate the selected deep link to gain direct access to the webpage without navigating through the website from a home page to the webpage; and

storing data relating to direct access at three levels, comprising a top level local cache in memory, a records cache and memory on a server.

Preferably, the top level local cache and the records cache are provided on a mobile device.

Preferably, the deep link is stored within a directory of deep links in a memory on a remote server and additionally in top level local cache memory, when the deep link is used in that log-in session, and in a records cache, when the deep link has been used in a previous log-in session. Preferably, the level of memory accessed is selected to reduce the time taken to obtain the required data. Preferably, the three levels are hierarchical such that a search thread seeking a selected deep link conducts searches in the order of: first, the top level local cache in memory; second, the records cache; and third, the server memory.

In a yet further aspect, the invention provides an apparatus for providing direct access to a webpage of an internet website, the apparatus comprising:

a memory storage for storing a structured directory of deep links, the deep links grouped according to a plurality of predetermined categories, each deep link representing an address of a specific webpage within a website corresponding to at least one of the predetermined categories;

means for enabling a mobile device to store at least some of the deep links.

Preferably, the deep links are stored in a plurality of different types of memory stores within the mobile device. Preferably, the memory stores include at least a top level cache and a records cache.

Method of Invoicing

In a yet further aspect, the invention provides a method for providing, by a service provider, user access to internet webpages, the method comprising:

the service provider establishing user links to a plurality of internet website pages in predetermined categories vetted by the service provider; establishing a session for accessing the vetted website pages; and

invoicing a fee to the user only once per session in which the vetted website pages are accessed.

Preferably, the links are accessible from a mobile device. Preferably, the fee is shared between a number of charging entities. Preferably, the fee is shared between the service provider, a service operator and the website accessed by the user.

Preferably, a new session is created each time the user logs in to access the vetted website pages.

In a yet further aspect, the invention provides a method as substantially herein described and/or illustrated by way of the accompanying drawings.

In a yet further aspect, the invention provides a system as substantially herein described and/or illustrated by way of the accompanying drawings.

In a yet further aspect of the invention there is provided a device for providing direct access to a webpage of an internet website, the device comprising:

means for providing a structured directory of deep links, the deep links grouped according to a plurality of predetermined categories, each deep link representing an address of a specific webpage within a website corresponding to at least one of said predetermined categories;

providing the user means to select a deep link from a chosen category and activate said selected deep link to gain direct access to the webpage directly without navigating through the website from a home page to the webpage.

In a still further aspect of the invention a server is provided for providing direct access to a webpage of an internet website, the server comprising a structured directory of deep links, the deep links grouped according to a plurality of predetermined categories, each deep link representing an address of a specific webpage within a website corresponding to at least one of said predetermined categories.

In a further aspect of the invention a computer readable storage medium is provided comprising a set of instructions for providing direct access to a webpage of an internet website, the instructions comprising:

code enabling a structured directory of deep links, the deep links grouped according to a plurality of predetermined categories, each deep link representing an address of a specific webpage within a website corresponding to at least one of said predetermined categories;

code enabling the user to select a deep link from a chosen category and activate said selected deep link to gain direct access to the webpage directly without navigating through the website from a home page to the webpage.

Further features of the invention are characterised by the appended claims. The invention extends to methods and/or systems substantially as herein described with reference to the accompanying drawings.

Still further aspects of the invention will appear from the description or preferred embodiments and the claims which follow.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

System or apparatus and method features may be interchanged as appropriate, and may be provided independently one of another. Any feature in one aspect of the invention may be applied to other aspects of the invention, in any appropriate combination. In particular, method aspects may be applied to system or apparatus aspects, and vice versa.

The present invention will now be described, purely by way of example, with reference to the accompanying drawings, in which:—

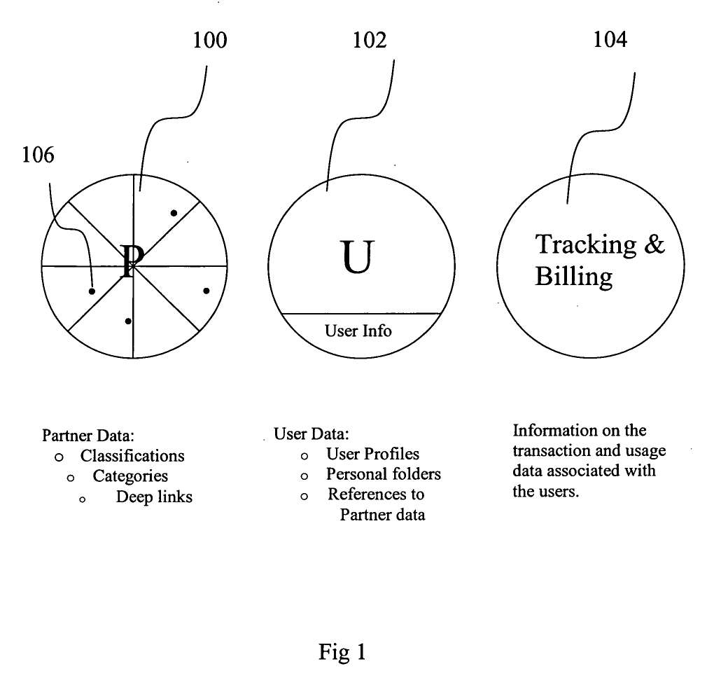

FIG. 1 is a pictorial representation of the data sharing between partner, user and third-party tracking and billing;

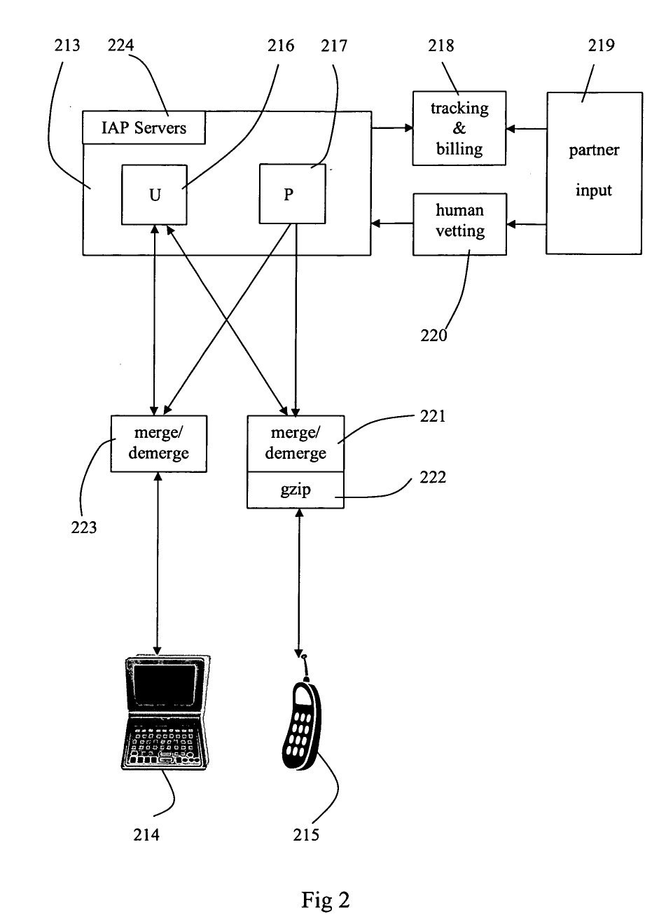

FIG. 2 is a broad schematic diagram of the IAP system architecture;

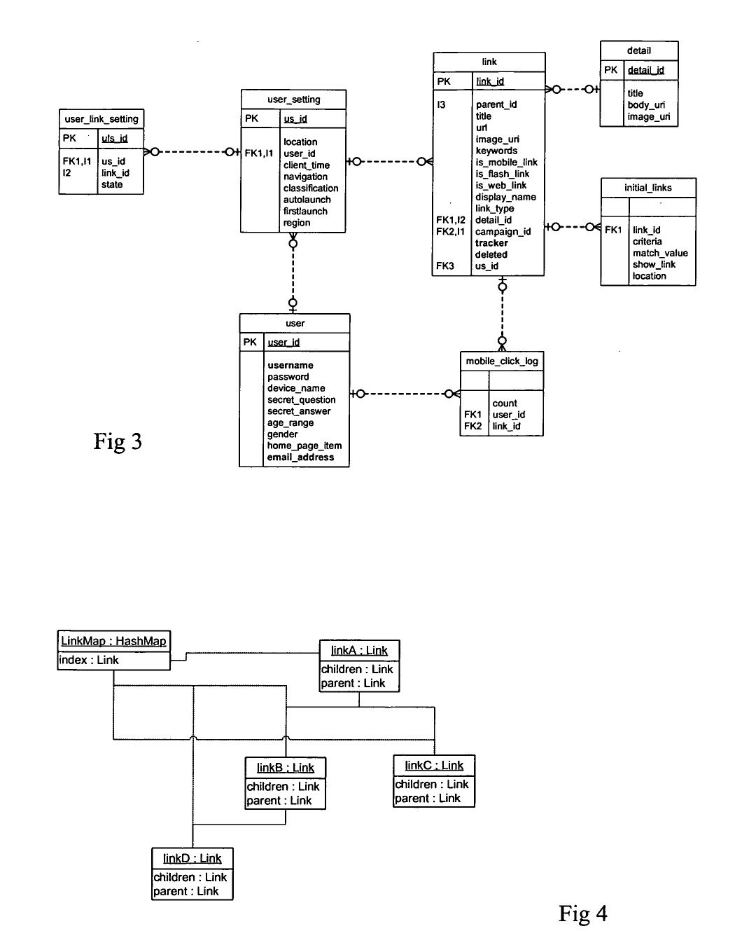

FIG. 3 is a block diagram of a database architecture for use in a mobile application of the present invention;

FIG. 4 is a schematic representation of a searchable memory structure for use in the present invention;

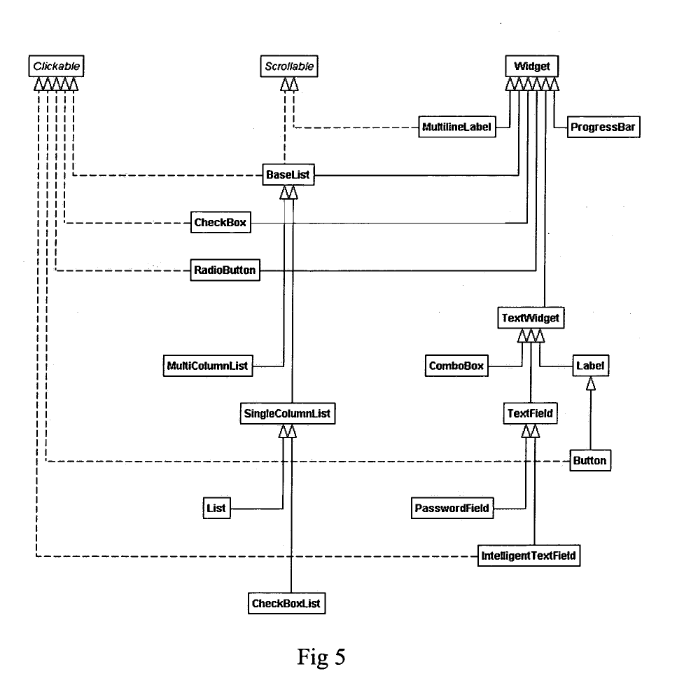

FIG. 5 is a schematic representation of the class diagram for a user interface toolkit employed in the present invention;

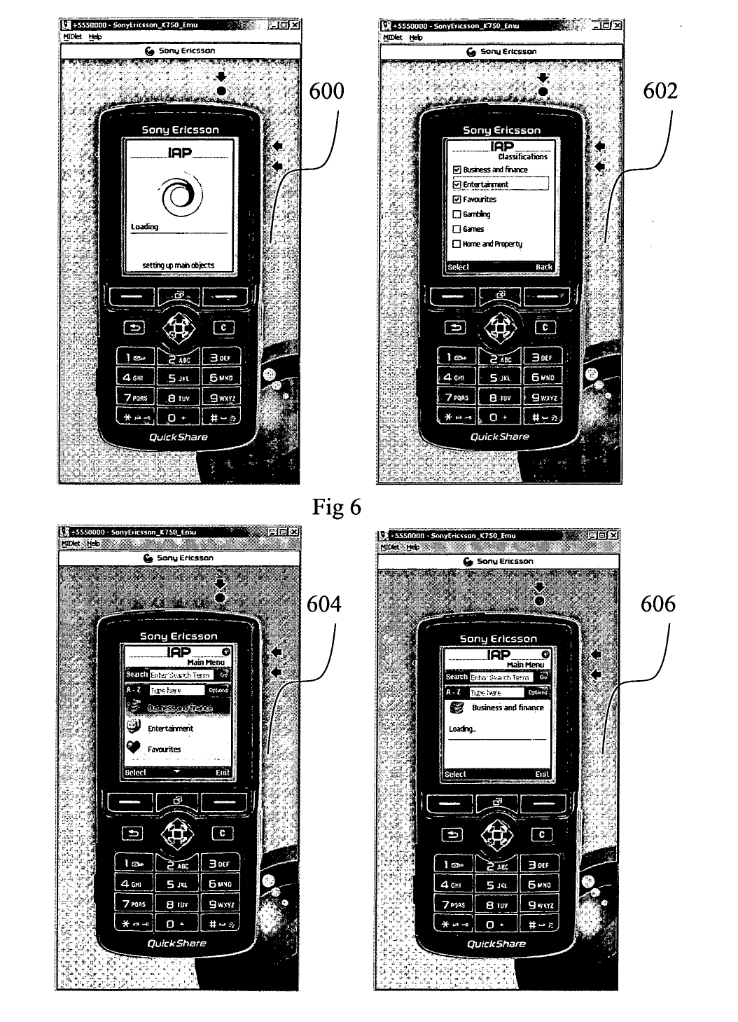

FIG. 6 show screenshots of example menu options in the mobile embodiment of the invention;

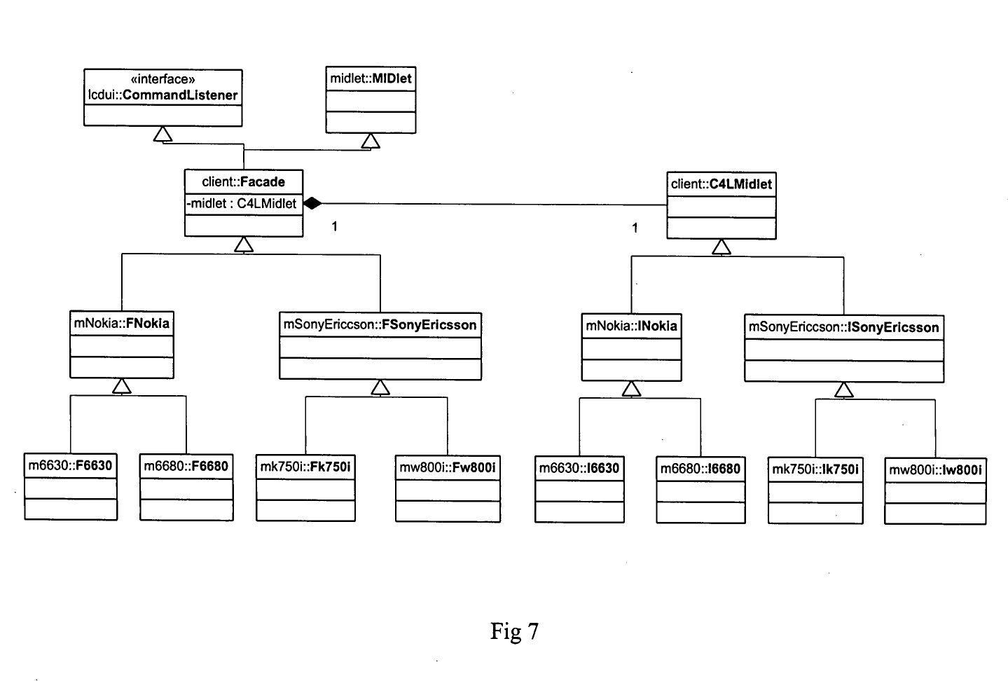

FIG. 7 is a schematic representation of the architecture of the client side of the invention;

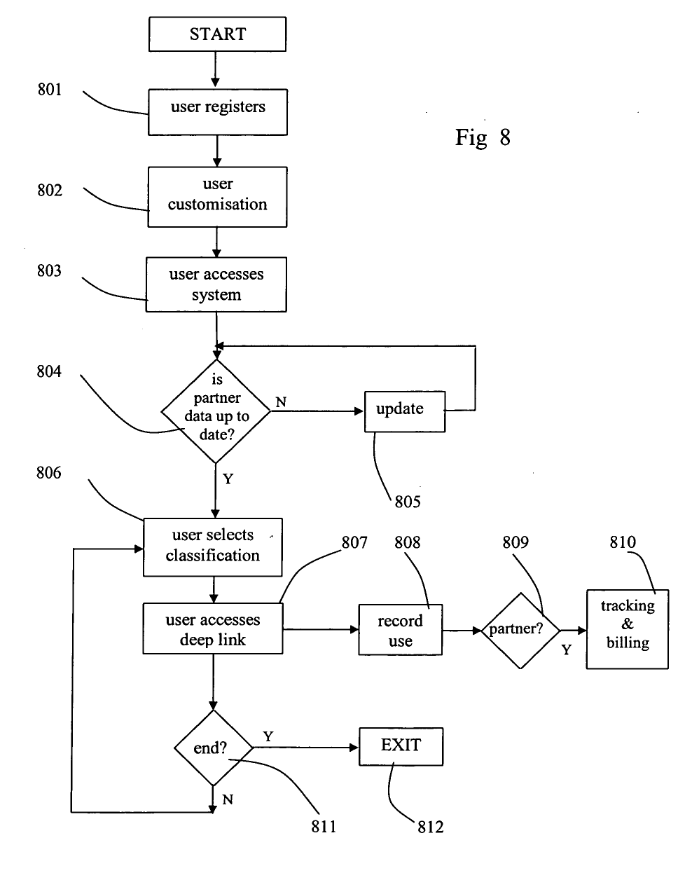

FIG. 8 is a flow diagram of a basic use of the LAP system; and

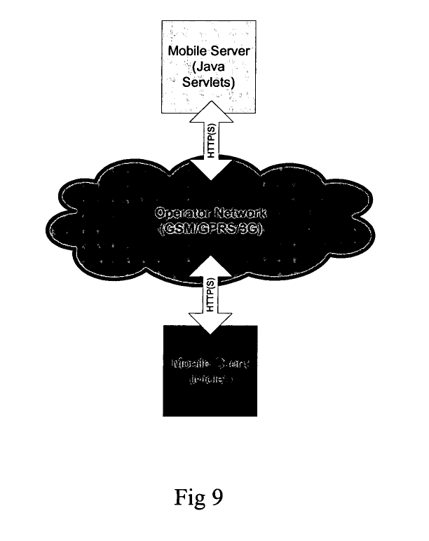

FIG. 9 shows a schematic representation of the global architecture of a system in accordance with the invention.

### DETAILED DESCRIPTION OF THE ILLUSTRATED EMBODIMENTS

Before delving straight into the details of the system provided by the present invention, it is useful to consider a technical overview of the facilities offered by the system and the benefits to the user, in order to put the invention into perspective.

Technical Overview

A solution has been devised pursuant to the present invention (known as an Instant Access Platform, IAP) for accessing and searching deep links over the internet by providing a searchable, Personal Internet Directory (PID), vetted by humans and updated simply by the user. A deep link is defined as a link to a specific webpage within a website. It is to be appreciated that this solution is not another search engine. It is in fact a directory of the best websites with relevant deep indexing into web pages within those sites as appropriate. It can provide virtually instant access to pages that suit the needs of the user and removes the need to go through countless search engine listings or to visit innumerable pages on a single website to get to a page of relevance.

The objective is to provide all of a user's online resources in a unique and intuitive way. Everything that a user normally does online is still available but it is organised sensibly and is accessible far more easily through the IAP. Because of the way in which the PID is set up, all the frustration of conventional website accessing may be removed from the user, saving time and effort and generating trusted, quality websites at a stroke. The user's own favourites can also be incorporated into the IAP service. Above all, the service can be made free to consumers.

Basic Functionality

The IAP service offers the following functions:—

A menu-style directory which enables a user to quickly access a wide range of quality websites required for everyday usage;

The menu is individually customised and classified to specific aspects of the user, such as gender, age range, location (country) and specified interests. Individual aspects comprise different “classifications”, which are set up by the IAP provider;

The PID can be downloaded (free to the consumer) as a toolbar (e.g. in Internet Explorer) and a launch page positioned in front of Internet Explorer, so that it becomes the consumer's first choice or point of access;

Each of the menu “classifications” can be further subdivided into “categories”, within which are listed the best UK websites (for applications within the UK) and, for each website, there are deep links to take the user directly to the required page on the chosen website;

If the user knows the address of the required website, he can type the first two or three (say) letters of the website in an “A-Z Search Function” facility and the chosen website will appear immediately on screen, together with the relevant deep links, requiring just a single click from there to get to the precise page the user requires.

Intermediate Functionality

The PID itself can offer the following features:—

A continuous “News” feed, with drop-down options for specific news topic feeds such as “Sport”, “Financial”, “Weather”, “Road Reports”, “Breaking News” etc, bringing them live and direct to the user;

All the major webmail and e-mail services can be delivered direct to the PID's “home” screen, allowing users to move on a single page between their internal usage and their e-mail or webmail facility;

The PID offers a drop-down box of all (currently five) major search engines, with deep links to the search facility required and will provide local search options in the drop-down display;

Users can readily integrate all their existing favourites and book-marked sites directly into the PID menu, including any automatic listing in the menu classification under the “Favourites” entry;

The PID can also carry a separate “blog” section, permitting the user to recommend new sites by category and giving individual websites, including existing websites, a “rating”. Thus providing a cumulative user assessment of the quality of the individual websites.

Applicability

The present invention can provide the IAP service to a consumer/user having an electronic device capable of communicating with the internet. This of course includes home- or office-based personal computers (PCs). However, the invention is not limited to PCs but extends to “mobile” computers, such as notebooks and Personal Digital Assistants (PDAs) equipped with internet capability. Moreover, the invention is applicable to truly compact mobile devices, known as thin clients, such as mobile telephones, BlackBerry devices (registered Trade Mark), hand-held or palm devices and any other mobile communication devices having internet capability, either inherently or as a “bolt-on.”

In the present specification, we concentrate on two main embodiments, the first being a PC-based system and the second a “mobile”, e.g. cell phone, system. Some of the features, architecture and program software described below are common to both, whereas certain other features are specific to the respective applications, as will become apparent.

Partner Data Types

There may be different types of partners, for who deep links are provided. For example, there may be “passive partners”, which merit being included as a consequence of the quality or value of their websites, or because they are popular. There may alternatively be “intermediate partners”, which act as agents to set up links between websites and those who want to earn commission by providing links to those websites. On the other hand, a “full partner” would negotiate directly with the IAP provider. In all cases, however, the links to the three types of partner websites are indistinguishable to the user. From the point of view of partner links, all the data is the same and is set up as a static set of links presented as a tree structure.

User Data Type

For each user on the server there will be a user database holding individual data sets specific to individual users, including user information (age, gender, location etc), user-defined links, and references to the partner data that is relevant to them.

General Description

The IAP interface can be used to find online resources directly. The user has access to a list of categories which themselves offer access to a range of websites with deep links within each site.

The deep links within the list of categories have been found, checked and uploaded by human operators as opposed to “spidering” software, which tend to take “snapshots” of websites at particular times and dates but without offering searchability. In the IAP system, each page will have been rigorously assessed to determine that it meets certain criteria to warrant its inclusion in the list. These criteria include content quality and security, to ensure that the site is reputable and valuable to the IAP users. An inherent benefit is that any websites inviting pop-ups, the potential for spam, or a bad reputation will simply be excluded. Such validation is continuous.

The service also has the capability of offering direct links to Voice Over Internet Protocol (VOIP) and direct access to all the major e-mail client providers.

There currently exists a database known as the mySQL database, which is a new leading edge cluster memory database, with 99.999% availability. MySQL is a multithreaded, multi-user, SQL (Structured Query Language) Database Management System (DBMS) with an estimated six million installations. It is available as free software under the GNU General Public License (GPL) and is becoming increasingly used as an open database facility, some parts of which are used by Yahoo.

In the present embodiments, by providing bespoke middleware, it is possible to handle several hundred concurrent calls to the database, which is built on a hierarchical basis with a built-in memory map. In mobile applications, indexing to the data tree is preferably carried out using Hash tables, in which a hashing function (algorithm) is created to hash the keys into hash buckets. Each bucket is a list of key-value pairs. Since different keys may hash to the same bucket, the goal of hash table design is to spread out the key-value pairs evenly with each bucket containing as few key-value pairs as possible. When an item is looked up, its key is hashed to find the appropriate bucket then the bucket is searched for the right key-value pair. If access to the values is desired other than through the keys then an indexing system can be built on top of a hash table. Such user-level search engines can be made to handle imprecise queries and misspellings. On the other hand, partner data need only be held in a static memory map that can be updated by the IAP provider.

The database employed for offering the classifications, categories and deep links to the user is common to all users, whether using a mobile device as previously listed, such as a mobile telephone, or whether using a PC-based system.

As well as providing the searchable directory facility, it is possible for “Partners” of the IAP service provider to present their services to the user. These may include “special offers” or other unique opportunities that the user can take up. For example, one or more of the deep links offered by the service provider can be a deep link to a particular page in a commercial partner's website. These may, in turn, lead direct to “special offers”, which could be made generally available or only to preferred/registered users of the service. This deep link will be flagged as a special offer page and stored in a special offer classification within the directory. The user can then go straight to that classification and access all of the special offers within the directory, as for all other deep links. The user may also find this page by going to the partner website link directly within the classification that it was always in. This could be a “private” home page accessible only to users of the LAP service, from which the user can navigate to pages within that private home page. Therefore, two routes are available to the same piece of information with the piece of information being stored only once, i.e. within the Shopping classification, CDs, Tesco (where Tesco has a special offer on CDs), and Tesco CD special offer within the special offer classification. (The deep is link only stored once, but two routes to get to it.)

Billing and Tracking

The system also provides the facility to track revenue from users, i.e. to allow revenue to be brought in and for the usage of any particular website to be monitored to facilitate negotiations etc. To this end, every click is logged on the server so if the user buys from the website then it can be noted and revenue generated. Usage is logged in such a way as not to permit the personal identity of the user to be revealed, e.g. through the use of personal id data instead of personal name. There is a separate tracking and billing database, which is held by a third party in the case of the intermediary partners as mentioned above.

It is relevant to note here that the same billing and tracking operation can be provided for the mobile application. The only exception is the possibility of a need to modify the mobile model plan in cooperation with a telecoms provider to allow that provider to make a small charge for connection to the IAP. The invention nevertheless offers a new source of income for some websites, whilst the technique allows for faster linking of users to websites via the IAP deep links, therefore reducing the total data downloaded. In the case of the mobile application clearly this will reduce costs. If a facility is cheaper, it will be used more often.

The billing and tracking server allows storage of users clicks to provide information to both the website provider and LAP to allow the most popular websites to be moved up in the rankings, i.e. the most popular deep link will be moved to the top of the list.

Data Storage

There are three databases in which data relevant to the service is stored, all at the server level, as follows:

(1) Partner data—Holds all information relating to the classifications researched by the IAP service provider, i.e. the deep links.

(2) User data—Holds individual data sets specific to individual users. This will include all of the user-defined links; references to the partner data that is relevant to them; their gender, age, location etc.

(3) Billing and tracking data—The ability to generate data that tracks users' clicks within the software. This data is then held by a third party, i.e. a specific internet shop or an intermediary. If a user goes to an internet shop and purchases an item the service provider may make money on that purchase depending on the contract they have, (if any), with the website. The user may not even need to make the purchase on that visit to the website. It is possible for the user to be tracked and then if he goes back to the website and makes a purchase at a later date, within 30 days for instance, then this may still generate revenue for the service provider. However, where there is legislation protecting an individual's personal data, such as the Data Protection Act in the United Kingdom, no specific data is allowed to be gained on individuals. Therefore the person is tracked using an id number and the information is held in a separate database so that there is no link between “John Smith” (say) and the information on the purchase he has made. All that is required for billing purposes is the knowledge that a purchase has been made.

FIG. 1 is a graphical representation of the type of data involved and the sharing of that data between partner (P) 100, user (U) 102 and a tracking & billing 104 entity. The last of these may be handled by a third party responsible for holding information on the transaction data associated with the users. The “dot” markings 106 in four of the segments of the partner circle P in FIG. 1 represent the specific data within the partner data that a particular user wants to have in their list of classes. This may be all of the partner data or any selection. One set of user data determines what partner data is shown and the user links that have been saved. All of the user data is uploaded to and downloaded from the server separately to the partner data information. This involves a function called merging and demerging of data, which will be described separately later.

In both the mobile and PC-based applications, the data structuring is similar but need not be identical. For example, data for the PC-based application may be in xml, which would be unsuitable for mobile applications because of the larger size of xml data. Mobile applications would therefore preferably use raw data.

The library of deep links can be marked for PC only use, or mobile only use. The user's keystroke history can also be sent to the server. The server knows the number of clicks for each entry, i.e. the number of times a certain link has been used, so it will then order appropriately, placing the link with the greatest number of clicks first and so on. This can be arranged to happen every time the handset is turned on. Nevertheless, there is synchronisation between the server and mobile, so that if the phone is lost, for example, the previous state can be restored to exactly the condition that existed the last time the system was used. This can happen when the user logs on to another mobile, for instance.

The user and server sides effectively control the content of the library. The system does not rely on the server for library content since it is all kept in local memory.

Categories within the Folder Tree Structure:

Individual categories are available within respective classifications in a Folder Tree Structure. The folder structure displays all categories associated with (i.e. within) a classification. The folder structure enables users to drill-down into categories and sub categories of an Affiliate Partner's Website by using expanding/collapsing folders. The way in which folders are presented is dynamic in the sense of how categories are viewed. If a user were to select the category ‘CD’s' within a classification, all sub categories associated with ‘CD’s' will be isolated by removing all other categories from view and by dynamically moving that part of the folder structure to the top of the folder tree structure. Navigation keys enable a user to move through folders in the tree structure.

Merging and Demerging of Data

In the instance of data sharing described with reference to FIG. 1, for example user data and partner data, there are certain technical facets that are now described.

There are two sets of records, partner data and user data, that are required to be cached locally to the user and also stored within databases at a remote location within a server. With multiple users of the IAP it is required that the partner data is stored only once within the partner server, and not in the user server, thus limiting the storage space required. Therefore when downloading the data from the user and partner servers the data is merged prior to caching locally within the users client. Likewise, when uploading the data from the user the partner and user data must be separated, or demerged, such that the user data may be stored on the user database and the partner data may be stored in the partner database.

A partner tree may therefore be used to store a user's own links. Therefore a typical user database entry will include; user details (age, gender, location, etc), user defined links to webpages, and a reference list to the appropriate partner data for that user. The partner database will include all of the classifications, categories and deep links provided by the IAP provider.

A general overview of the merging process, including a summary of how files are organised, is represented in the following steps, see FIG. 2:

a. File organisation:

i. Partner and User data are in different XML.
ii. Partner data changes by country.
iii. User data is the same for all countries.
   b. Merging process:
i. Parse Partner data in P.
ii. Parse User data in U.
iii. For each folder f under U root:
   1. Bind f and its subfolders and links to the category/subcategory or classification in P with id=f.parentid.
   2. Add location in memory of f to a list named L.
iv. For each user link l under U root:
   1. Bind link l to the category/subcategory or classification in P with id=l.parentid.
   2. Add location in memory of l to a list named L.
v. Work with P in the UI.
   c. Splitting process for SetUserData:
i. Read previous and new user data location from L.
ii. Build U2: For each folder or link stored in L:
1. Link U2 to this folder and link and make parentid equal to r.parentid.
   Mobile Device Architecture Overview

In this section of the specification is discussed the application of the invention to mobile devices, especially, but not exclusively, mobile telephones, often referred to for brevity here simply as “mobiles”. The overall architecture for the mobile application follows the basic principles of serving information to a client over the Internet. A backend server conforming to an n-tier architecture serves content derived from a database transformed by middleware into user specific data and is then transported via a front end. In the present case, each front end server is termed a “Servlet”, which can be regarded as a satellite to the main, backend server. Data transport makes use of http over the internet to the operator network and then out to the mobile client. The mobile client comprises a java midlet running in a MIDP2.0 compatible device. The essence of the system offered by the present invention resides in this midlet. A broad view of the IAP system architecture is given later with reference to FIG. 2.

It should be explained for completeness that MIDP is an acronym for Mobile Information Device Profile, which is the normal Java runtime environment for the most popular current compact mobile information devices, such as cell phones, palm/handheld devices and mainstream PDAs. A MIDlet is a small application which is written in the Java programming language and which runs in all mobile phones and two-way pagers that support MIDP. At present, Windows is the only platform on which the MIDP reference implementation is certified but the Connected Limited Device Configuration (CLDC) is available for the Windows and Solaris platforms, whereas the JDK platform is available for Windows, Solaris and Linux. Midlets can be downloaded and installed in mobile devices, such as mobile phones and can be customised by the user. More information is available from Sun Microsystems Inc.

Midlets have hitherto been mostly restricted to games applications, providing internet access and HTML screens on mobiles via a server. They tend to operate by responding to a client request by re-rendering the requested page and sending the response back to the client. Since midlets also tend to draw a page pixel-by-pixel, they are not normally ideal for customised controls. Moreover, midlets have not previously been used for business applications, largely because business applications in general are not inviting on mobile telephones. The present invention offers professional-looking business applications, which has not been achieved before now.

In the following sections, a more detailed overview of the functionality of key aspects of the overall system is described. The overall system involves a head-end server providing the “global” service, and a client side server interfacing with the user. Various aspects and facilities of both are outlined here.

Server Side Architecture

This section concentrates on the general server architecture as it applies to the application of the invention to a mobile phone system.

Database Architecture

The database architecture relevant to the mobile system is shown in FIG. 3. All information regarding classifications, folders and deep links are stored in the “link” table. The user_table stores information about the user, including username, password and device type e.g. Nokia 6680. The user_setting and user_link_setting tables store information regarding the state of a link on the user's device, thereby permitting different classifications to be open, closed or disabled for different categories of user based on age range, gender and location. For example, users under 16 are unlikely to be interested in business and finance. This functionality is further augmented by the initial_links table, which stores the initial state of a link to allow default behaviour, given the demographics of a new user supplied on signup.

Middle Tier

The middle tier is shown in FIG. 4. It comprises a set of database access classes, i.e. classes used to model links and the business logic required to associate the links to form a hierarchical structure. The data structure in itself is not complicated but the initial call to the server results in a very intensive data gathering function. This could theoretically call the database many thousands of times to build the information required by the client. This might create an application performance problem, as the download speeds available on a thin client will be limited. Therefore, in order to alleviate this problem and spread the processing load, memory modelling of the generic data is performed in the middle tier.

The key model class is the Link class. This class represents classifications, folders and deep links. Using this class makes it possible to create a bi-directional linked tree (e.g. a Patricia tree) that the server code can traverse from parent to child and vice-versa. Each link object maps a single row in the database.

In addition to this tree structure formed by Link objects, a map is used which is keyed on the link id to index the tree to allow instant access to any part of it. Intelligent caching is used on the server side to preload generic data into the singleton in-memory map comprised of the above objects. This in-memory map is updated at intervals, preferably every 5 minutes (configurable) or so, by a daemon thread running within the application. When a call is made by the client for information, for example getMainMenu, the in-memory map is used to optimise performance by eliminating unnecessary calls to the database. User specific data, referenced by entries in the link table and the user_setting table, is then parsed into the tree, thereby creating user specific links, for example My Favourites from internet explorer. Cloning is used so as not to insert user specific data into the generic tree.

The data is then formatted as a single, character delimited string, compressed using the gzip algorithm, optionally encrypted, and then sent to the client in the HTTPResponse.

Mobile Client Side Architecture

A preferred arrangement for the client side architecture is represented by FIG. 5. The client is formed by a MIDP2.0 midlet running in a mobile device. Although all MIDP2.0 devices should conform to the specification, not all devices conform in the same way and not all devices behave correctly. This poses somewhat of a problem in that it implies that a different code base is required for every device. The client side architecture allows for rapid rollout onto new devices through the use of specialisation classes. A facade pattern is used to both provide a unified set of interfaces and also to allow for easy obfuscation of the implementation code.

The core code of the midlet is defined in C4Lmidlet. Code that is common to all devices is contained within here. A package is then defined per manufacturer, and then a package per device. The packages contain façade and implementation classes in a manner such that code common to all devices from one manufacturer can be reused at the same time as providing specialisation classes for particular devices to work around either different screen resolutions or bugs particular to one device.

User Interface (UI)

The normal choice of creating user applications on a mobile device is either XHTML/WAP or midlet, depending on the type of application to be created. XHTML/WAP is generally used for browsing graphically rich content or “lite sites”. Midlets are typically used for games. The IAP is preferably a business application that does not necessarily conform to either situation. Using XHTML/WAP would permit the production of a graphically intensive experience, but usability would be poor as round trips to the server would be required for every request and this would not allow the higher functions of the device to be accessed. Using a midlet typically would permit the immediate display of many pages, unlike XHTML, and at the price of a simple display.

Standard user interface tools open to a midlet developer are fairly poor and rely upon the devices' own implementations. This means that on any given device the look and feel could be very different to another device running the same code. In addition the supplied controls are basic in appearance and not particularly attractive. This has been addressed by the use of a specially developed and dedicated UI toolkit, based upon the GameCanvas support within the midlet infrastructure for games development. Consequently, all operations from key presses to rendering user controls on screen have been developed from first principles, thereby resulting in unique user screens.

In contrast, most midlet developers either create games using the GameCanvas or create business applications based upon the lcdui packages. In the case of the present invention, however, the IAP toolkit has been written in such a way that it can be packaged separately from the IAP midlet and provide graphically intensive business application user interfaces to other midlets. Examples of screen shots illustrating typical menu options and progress indicators are shown in FIG. 6 to give a flavour of the professional appearance of the service whilst still providing a simple menu system and the use of icons, which has not been implemented successfully in business packages before now. Referring to FIG. 6, screen shot 600 shows the loading screen; this screen is shown to the user during start up. Screen shot 602 shows the user selectable classifications; the user may select (or unselect) classifications according to their preferences. Screen shot 604 shows the main screen of the mobile IAP; the A-Z feature may be seen, together with the search tool and classifications. Screen shot 606 shows another type of loading screen; this is shown when information is being downloaded from the server.

UI Toolkit

The user interface (UI) toolkit has been designed in such a manner that it is possible to separate the toolkit from the rest of the application. This UI toolkit package can then be marketed separately. An outline of a class diagram is shown in FIG. 7. The major components of the diagram are outlined below:

WidgetScreen

WidgetScreen is the core container class in the package. A WidgetScreen is a logical display that contains 0 or more widgets and a menu bar. The widget screen is responsible for painting itself, i.e. the contained widgets and the menu bar. A developer would be able to add widgets to the container through the use of the addWidget method. Access to the physical screen on the device is via the ScreenProxy class. A single instance of the ScreenProxy class per virtual machine is maintained by the WidgetScreen class and is used for proxy painting events and keypress events between the logical screens and widgets and the physical device. The HandsetCharacteristics interface is used to provide abstraction from the physical dimensions of the device and the different key codes defined when a user hits a key.

ScreenProxy

The ScreenProxy class forms the gateway between the UI toolkit and the underlying MIDP2.0 architecture. ScreenProxy extends GameCanvas, always operating in full screen mode, and by doing so extends the full canvas area to the toolkit. Key press events are proxied from the device to the relevant WidgetScreen through the ScreenProxy. Paint events are proxied from the current WidgetScreen (or Widget via its containing WidgetScreen) to the device through the ScreenProxy. Screenproxy is a new function, hidden from the software developer, who would see only the widget screen and nothing else. Screenproxy ensures that maximum screen size is used for all applications, regardless of network, handset manufacturer and model. It allows the operating software to access that screen, a widget screen a pane or a window. It can be regarded as a stepping stone from raw screen to panes etc. Moreover, it enables the goal of applying technology on many machines to be achieved, combined with Handset Characteristics (see next paragraph). ScreenProxy can cleverly resize—expand or contract—for each screen size. Any multi-mobile application will need this.

To ensure that the on-screen representation is correct at all times, a paintImmediately method is implemented, which uses the underlying getGraphics and flushGraphics method to paint the individual pixels on the screen at the correct time. Focus is a screen proxy link between screens with controls and the actual screen. It is therefore possible for the same physical screen to be used by virtual screens.

HandsetCharacteristics

The HandsetCharacteristics interface defines a number of methods that allow the UI toolkit classes to interact correctly with the underlying device. Methods are provided to allow the UI toolkit to retrieve the device's screen height and width and the relevant key codes for the control keys. In addition the getChar method allows the developer to supply a custom map to define the order of character input on the device.

Widget

The widget class is the super class (core class) for all user interface toolkit elements. Methods are defined to allow many types of generic default behaviour that a Widget may display, for example, background colour and font. A paint method is defined that handles the most generic paint operations. A Widget is responsible for knowing where on the WidgetScreen it is painted. Widgetscreen allows UI to be designed by game system. Methods are therefore supplied to allow the mutation of the x and y coordinates on the screen. Certain types of Widget need to be able to display different types of behaviour based on whether they are currently selected or not, or indeed whether they are able to be selected at all. In addition, certain Widgets may be able to take control of the application when they are selected. Both of the above cases are specified in the Widget class.

TextWidget

TextWidget is an abstract subclass of the Widget Class that provides generic functionality for Widgets that deal with text. As all of the UI toolkit classes have been written from first principles, the method workOutDisplayableText( ) is defined within TextWidget. Unsurprisingly this takes the size of the widget from its super class and truncates its displayable text to the maximum size that can be displayed in its portion of the display.

IntelligentTextField

IntelligentTextField allows the input of predictive text and is a subclass of TextField, which in turn is a subclass of TextWidget. This Widget is used within the application to provide the A to Z functionality. The setOptions method is used within IntelligentTextField to allow the setting of an array of values. The inherited functionality is used to allow the user to enter text. If this text potentially matches any of the options, a scrollable pop up box is displayed to allow the user to jump to the desired option.

Client Side Caching

Client side caching is utilised to improve the user experience of the IAP, as data transfer between a client and a server is sometimes not ideal. It is unknown whether the client will have continuous good data transfer rates, or even be connected at all, so the client must deal with the situation effectively where the server is not available. In addition to this, data transfer rates at times may be very poor and latency of requests very high, in which case the time taken to move from one page to another can be several tens of seconds. A large number of synchronous calls to the server result in a very poor user experience, as often encountered in WAP-enabled devices. The smaller the amount of data that can be transferred between the client and server, the better.

In recognition of this, the IAP midlet employs a two layer cache, asynchronous loading and compression of data to minimise round trips to the server and the amount of data that is transferred synchronously.

The memory for storing deep links is composed of a top level cache in memory, a records cache and memory at the server. The system also offers such advanced features as look-ahead typing (as the user types, the cached memory/records memory is brought up) which has not previously been done on mobile applications.

On initial start up the midlet gathers demographic information and sends it to the server. The main menu and A to Z information is then downloaded synchronously and displayed to the user. In the background a thread is spawned which asynchronously downloads further folder and deeplink information and stores this in the device's record store. The information downloaded asynchronously will be dependent on the user's previous actions. For example if when the user previously used the IAP he first went to the Business & Finance classification and then onto the Games classification it will be presumed that the same sequence will be used again. Thus information will be downloaded with reference to the order of information required on the previous use of the IAP. The record store is a non-volatile database allowing the midlet to persist data across several sessions. Thus, when the user next turns on the application, the record store is interrogated to see if cached information is stored. If this has not expired (by being older than a configurable length of time) this data is used instead of contacting the server, saving several round trips and optimising the start up time.

A second in-memory cache is used during operation. Like the server side, an in-memory map of Link objects is used to map the data, the link objects in this case being lighter in implementation to save memory. This second level cache is used because accessing memory is far quicker than accessing the device's record store. This caching gives the user a far better experience as the move from classification to folder, sub folders and eventually deep links is achieved far quicker.

Lazy Loading

CPU and memory resources on mobile devices are severely limited. As a result, start up times of complicated applications can be very long. The technique of “lazy loading” is used within the midlet to allow quicker startup. The UI is comprised of a number of WidgetScreen objects containing multiple UI widgets. These objects take time to create and associate. It is therefore preferable to accept a compromise, whereby the option screens are not created immediately at start up. This gives a faster start up time as only the screens needed are instantiated. In this manner, only the functions that the user sees on screen are done immediately whilst the others are still being established. In essence, the start-up routine is just-in-time (JIT) loading. In addition the midlet takes into consideration the registration status of the user. If the user is already registered, the registration screens are not instantiated. If the user is not registered, the screens are instantiated, but nulled on successful registration to allow immediate garbage collection and freeing of valuable memory resources.

Upgrading

The client can periodically check the server to see if any updates to the client software have become available. Should any updates be available, the user is notified of this fact and is given the opportunity to update automatically. If the user chooses to update, the device's browser is launched and directed to the location of the new update. The midlet then shuts down to allow the device to update its own software.

The Mobile-Based Embodiment

The present invention, as applied to mobile phones, operates in the area of “thin clients” i.e. network “computers” without a hard disk drive. As previously mentioned, the software behind the present invention can be applied to any mobile that supports midp applications, which are downloaded to the device in question in Java programming language. In the present context, a network “computer” includes intelligent devices with internet capability, such as mobile telephones, palm/hand-held devices etc.

The present embodiment is not specific to any one particular brand or type of mobile, such as Nokia, Motorola etc. In the drawings, see FIG. 6, Sony Ericsson mobiles are used to illustrate the kind of menu options offered to the user but this is simply a matter of convenience and is not intended to indicate that the invention is restricted either to the particular brand of mobile or to any particular model within that brand. The software is specifically designed to be applicable with any mobile.

Information regarding the type of device is stored in association with the geographical location of the device. The information downloaded from the server may therefore be region specific to enhance the users experience.

When the user starts up the device utilising the service underlying the invention, a number of things happen in the background, out of the sight of the user. First, a memory map is accessed to check for entries in specific data fields, second a record store is accessed and finally the start-up request is sent to the server. This hierarchical technique enables the service to be started quickly and in a way that enables the user to perform his “normal” operations at the same time as the software is loading. For instance, the request goes to the server at the same time as a message appears on screen informing the user that loading is in progress.

An important feature of the start-up routine is based on the expectation that the user will repeat the actions he took last time he activated the device. Therefore, the start-up routine presents to the user as the first item, the information that he wanted first the previous time. The server logs the clicks made by the user, then re-orders classifications on the device every time the application is logged.

The use of a cache for the directory makes this task possible and thereby improves the speed of the system. The operating software (midlet) calls on the server to refresh the data on the device. There is an asynchronous thread in the midlet which picks data from the server. Meanwhile, in the background, the device, e.g. a mobile phone, signals to the server to populate the memory. This happens while the user is performing other activities on the phone, such as typing information into the phone.

As part of this operation, the software checks the parts the user is most interested in first then goes to everything that other people are interested in and, if necessary, everything they have in the database. Finally, the relevant data is placed in the records store.

The store for records of this kind of action is part of the midlet. Because the use of the record store is slow, it is the lowest level of storage so that it does not get in the way of instantiating the services normally required by the user at start-up.

The chief advantage of using a midlet to control the above operations rather than writing the program in a language specific to the device or writing it for a browser, is that with a browser, there is not the same functionality. Every time the user wants to visit a page, he would have to go to the server, which does not have the functionality to remember everything that the user has done previously. On the other hand, the midlet “remembers” the user since it has been customised to the user. In the application to mobiles, it is the equivalent of a desktop application to an internet browser.

The mobile application reduces the amount of data being transferred because the users access the desired sites more easily (by having a vetted directory, customised to the users' information) and go to the desired page of the particular site via deep linking.

Another advantage is that the midlet can either be pre-loaded to the user's device or can be downloaded from the server. Moreover, if the application becomes out of date, the system has the inbuilt capability of checking the version being run on the device and upgrading, either automatically or with a single key stroke by the user as part of a menu option.

The same pattern of data storage is used on the server side as on the client side to optimise the speed at which they produce data to the user/client. In order to increase transmission speed and to improve security, the data is in the form of encrypted https, which is then zipped at the server and sent to the client/user. The preferred version is gzip, which has not previously been used in mobile applications.

Furthermore, the software operating the service does not need to be written differently for each and every network, handset manufacturer and model. In that sense, the software is universal. The use of a “smart” user interface for all devices provides this universality.

Implementation by way of a midlet written in java removes the graphical limitations of known solutions and moves the invention out of the realms of purely games use to business use but still retaining all the benefits of functionality and appearance. The business application effectively uses games technology to provide the business applications graphics. Widgets provide such features as individual text fields and scrollable text etc, whilst the client side architecture makes it possible for the provision of checkboxes and animation to icons in a side bar displayed on the handset screen. Hence the present embodiment involves a combination of games features in a business application.

The service can simply be offered to any mobile and can be used for any application. The creation of a development toolkit permits the further development of future applications using widgets.

As regards the storage of data on the mobile handset, it is another feature of the present embodiment to provide memory mapping in which caching is effected on the telephone side of a system. In contrast to the PC-based system, the mobile-based system caches deep links in the midlets. However, litesites are used in the mobile application, to ensure that content is viewed properly, although the same bookmarks can be displayed on both the PC-based and the mobile-based systems. The system also offers the facility of providing access to a contact database held in the handset.

Trusted applications are only allowed access to the system to perform certain, approved tasks but they are not allowed to embed Internet Explorer into the application, so it launches it separately.

The PC-Based Embodiment

Turning now to an application of the present invention to PC-based devices, such as desktop computers, the basic functionality and architecture is explained; this uses the basic building blocks now to be described.

The AP is integrated into Internet Explorer, Outlook and Outlook Express in the form of an additional toolbar. This enables the user to combine his usual browsing methods with the benefits of the IAP's functionality.

The A-Z Feature

A-Z Functional Overview:

The A-Z feature, which provides the searching capability, allows a user to type alphanumeric entries into a combo box within the LAP UI or a Toolbar installed into third party Windows software. The A-Z feature compares the input alphanumeric entries with the “displaynames/alternates” attributes of all the IAP Links and highlights any that match the leading alphanumeric entries stored. The user can then select or preview one of the matches depending on where they are using the feature from, as follows:

(a) when using the A-Z in the IAP UI, the matches are shown in the Deep Links Area, with the top item auto-rendered in the Preview Pane.

(b) when using the A-Z from a Toolbar, the matches are displayed in a drop box and if any entries are clicked this will cause the IAP to display the highlighted Link in the Preview Pane (in the process, starting up IAP UI if it is not already running).

The A-Z feature continues to filter the matches shown if further alphanumeric entries are entered into the combo box, until no matches can be found. As the possible matches are shown in the drop box, the website associated with the currently highlighted element is also loaded into the deep links area and rendered in the preview area.

There is no restriction on the number of alphanumeric entries that can be typed and matched, nor the number of matches shown.

Components, Architecture & Technologies:

The A-Z feature is provided via a ComboBox set within IAP Installed Toolbars for IE/OL/OE and also directly embedded within the IAP interface itself. Each of the Toolbars is coded using C++ for performance and maintainability, with the OE Toolbar using the Nektra Toolkit.

When using A-Z within the IAP UI, the A-Z feature uses the LAP process to access directly the A-Z Indexes in memory.

When using A-Z from a toolbar, the feature uses IPC (Inter Process Communication) to send messages in XML to the IAP Process (acting as a DataBroker), asking for nodes beginning with the input string and returning with an XML message of all nodes matching.

The IAP process is started each time a user logs into windows and runs all of the time. It does not require the IAP UI to be running.

The A-Z Data and Associated Structures:

The A-Z Data is made up of the full Partner and User Data combined. The A-Z Data is a single, common index accessed via the various Toolbars and IAP. The A-Z Index consists of a single alpha ordered list of Displayname and AlternateDisplayName attributes, with associated vectors pointing to a de-serialised representation of the full XML data nodes in the Main Consolidated IAP DataStore, held and updated both in memory and on the filesystem.

The A-Z Index is essentially an ArrayList held in memory, which is queried using a typical Binary Search (Dichotomic Search) to find the first occurrence of a matching entry and to build a structure to return all matching entries. The A-Z Index is initialised when the IAP process starts at Windows Login and is updated when partner or user data is changed. In some cases the index is completely recreated in memory as being the most efficient update process, for example when a large volume of partner data is updated.

A Typical Operation of the PC-Based System

The IAP system is provided on four platforms—these are the IAP UI, the IAP toolbar Client (Internet Explorer, Outlook and Outlook Express) the IAP flash Website, and the LAP mobile application.

The IAP UI enables the user to interface with the IAP as a launch page sitting in front of an internet browser. This version will provide full functionality; including the menu of classifications, a display pane, RSS news feeds and webmail depending on user preferences.

The IAP toolbar client enables users to access the IAP Affiliate Partner Websites and manage their own favourites links via an intuitive software interface. Once installed, the IAP software application seamlessly integrates a toolbar into Outlook, Outlook Express and Internet Explorer, facilitating users with improved access to credible online content.

The IAP Website presents users with a ‘static’ directory of all the IAP Affiliate Partner Websites which can be accessed through an intuitive, flash-driven web interface. The IAP Website is not customisable and does not require a user to login in order to make use of its functionality.

The IAP mobile version provides users with all the benefits and features the IAP toolbar client offers but allows its users to access information and content on the move (via their mobile handset).

Download & Installation

The IAP application can be downloaded and installed from the IAP consumer Website as a CAB file and/or by manually downloading the .exe file. Automated Download and Installation is a more sophisticated means of installing the application as it does not require user intervention for installation to occur. Manual Download allows users to download an .exe version of the application in the event the automated mechanism fails. Once the .exe file has downloaded to the user's PC, the user is required to ‘double click’ the installer in order to begin installation.

The installer registers all relevant software components within the user's PC environment and embeds a local data structure (XML Data Store) for storing/updating Affiliate Partner Websites (and Personal Links for reinstallation only). Any updates to Affiliate Partner data (which always derive from the server) overwrites the local store of data—however, overwriting data will not remove any customised elements such as user added links specified by the user for persisting data and folder structures.

Once a user has installed the IAP, a toolbar is integrated within the top panel of the browser and/or email client. Instantly after installation is complete the IAP automatically opens and prompts the user to create a user Account.

Once the IAP has launched automatically a registration screen appears, prompting the user to register a new user Account and/or sign-in to an existing Account. This provides a unique identifier and is made up of letters and alphanumeric characters (preferably a minimum of 6 characters—both letters and alphanumeric). Validation may be necessary to ensure both letters and alphanumeric characters have been used to create a user Account. Appropriate error messages may be displayed if, for instance, the server is unavailable/busy or the user is not connected to their ISP. The user may also be permitted to customise his/her IAP Home Page.

Once this has been done, the user is required to define the parameters which set the classifications and their default homepage view. The parameters include; age, gender, location, special interests etc. These parameters will be used to define the user profile and therefore the classifications shown to that user. Dropdown options depict the parameters which set a user's classifications and default homepage view. A ‘Country’ field is a mandatory requirement to ensure that an appropriate set of available classifications are made available to the user. This is preferably associated with factors peculiar to the user, such as age. A possible matrix of age versus available classifications is shown below.

| | Age Range | | | | | | | |
|---|---|---|---|---|---|---|---|---|
| | 13-18 | | 19-35 | | 36-55 | | 55+ | |
| Classification | Male | Female | M | F | M | | M | F |
| Arts/Culture | | | Y | Y | Y | Y | Y | Y |
| Business/ | | | Y | Y | Y | Y | Y | Y |
| Finance | | | | | | | | |
| Celebrity | Y | Y | Y | Y | Y | Y | Y | Y |
| Entertainment | Y | Y | Y | Y | Y | Y | Y | Y |
| Favourites | Y | Y | Y | Y | Y | Y | Y | Y |
| Gambling | | | Y | Y | Y | Y | Y | Y |
| Games | Y | Y | Y | Y | | | | |
| Health/Beauty | | Y | | Y | | Y | | Y |
| Health/Fitness | | | Y | | Y | | | |
| Home/Garden | | | Y | Y | Y | Y | Y | Y |
| Info/Media | Y | Y | Y | Y | Y | Y | Y | Y |
| I.T/Computers | Y | Y | Y | Y | Y | Y | Y | Y |
| Jobs | | | Y | Y | Y | Y | Y | Y |
| Music | Y | Y | Y | Y | Y | Y | Y | Y |
| My Bills | | | | | | | | |
| My Work | | | | | | | | |
| Property | | | Y | Y | Y | Y | Y | Y |
| Services | Y | Y | Y | Y | Y | Y | Y | Y |
| Shopping | Y | Y | Y | Y | Y | Y | Y | Y |
| Special Offers | | | | | | | | |
| Sport | Y | Y | Y | Y | Y | Y | Y | Y |
| Travel/Leisure | Y | Y | Y | Y | Y | Y | Y | Y |

Customisation of the IAP Homepage

A drop down box enables users to register their age range, gender and selected country. In addition, the user can select from a list a preferred RSS feed that is rendered within the Preview Panel every time the IAP application is launched and/or the ‘Home’ button is clicked. However, users are able to flick between the other RSS feeds by refreshing the view of the Preview Panel via a dropdown of options within the Interface (displaying ALL RSS options). The last RSS viewed will not persist—the customized settings collected within the registration will always take precedence. Examples of such RSS include—Breaking News-Business-Celebrity Gossip-Entertainment-Music-Politics-Sports-Stocks and Shares News-Technology-Weather, for example.

Completing Customisation

Once a user has completed customisation and clicked ‘Confirm’, the tailored dataset and live feeds for specific news are set within the user's account. Specific settings relating to a user account are also sent to the server in order to persist the settings for future updates to partner data, software upgrades to cater for single user accounts on multiple PCs.

The Default IAP Home Page

The IAP Interface ‘state’ for displaying RSS topics such as Breaking news, Sports, etc will be known as the user's IAP homepage and can be accessed whenever the IAP is opened and/or by clicking the ‘Home’ button. The IAP homepage will display the most up-to-date content available from the providers of the RSS sources. However, selecting to use any of the functional aspects within the Interface when in the homepage state will cause the Preview Panel to retract to the minimum view.

The IAP Interface

The IAP interface allows the user to drill down into classifications, categories, sub-categories and finally deep links. The classifications shown, as discussed previously, will be dependent on the user profile. The classifications will be displayed in a menu style list within the IAP UI, the location of this menu will be dependent on user preferences.

Deep Links

Any URL's in the form of a URL title (Deep Links) that are associated with partner folders within the folder tree structure are displayed for user selection. Deep links can be used (a) to preview a Website within the Preview Panel by clicking once on the URL or (b) can be double-clicked to launch a Website in a separate browser. Clicking a Deep Link once will load the Website within the Preview Panel. Double-clicking the Deep Link will cause a new browser window to open and load the specific web page. In the event a classification is hidden/removed from the Classification menu, the Deep Links associated with the hidden classification should still be accessible/visible through the IAP Interface—The Top Deep Link of a Website folder is automatically loaded within the Preview Panel. If there is only one Deep Link associated with a folder than that URL should load within the Preview Panel.

Users will be able to clear the history of Websites they have visited by simply clicking a ‘Clear History’ option situated at the bottom of the dropdown menu. If this option is selected, a confirmation dialogue box will appear prompting the user to confirm this action. Previously visited Websites will be stored within an address bars dropdown.

Preview Panel

A Preview Panel contains live Websites and becomes populated when a user clicks a Deep Link, selects a search engine or web mail option. Once a selection has been made, the chosen Website is loaded within the Preview Panel and refreshes whenever a Deep Link, folder, classification or navigation on the live Website is selected. The Preview Panel can be viewed in two states:

Expandable/Retractable Preview Panel: This enables users to view Websites within the Preview Panel at an optimum size. A maximise and minimise button is positioned at the top of the Preview Panel, enabling users to click maximise (as in Internet Explorer) to expand the preview. Maximising the view causes the Preview Panel (containing the live Website) to overlap the Deep Links section and folder tree structure. To minimise the view, the user would simply click ‘minimise’ to reduce the Preview Panel to its default size.

A-Z Functionality

The A-Z function displays a list of Deep Link results as one click options. For both toolbar and Interface A-Z results are achieved by referencing any letters typed into the A-Z text box against partner data (URL titles) held in the local store of data. The A-Z results are refined by each letter typed into the A-Z text box down to the nth level.

Toolbar Version

The A-Z dropdown (toolbar) includes categories and specific Deep Links within the dropdown list when referencing data. Any category and Deep Link displayed will be listed alphabetically—however the category should be visually differentiated from the Deep Link options.

a. If a user were to click on a category from the dropdown this would cause the IAP Interface to launch with the folder tree section open at the appropriate point (showing the chosen category open) with no other categories expanded (in view).

b. If a user were to click on a Deep Link, the web page would be loaded within the browser window.

Interface Version

The A-Z function (interface) works exactly as the toolbar—however, all options will be displayed within the Deep Link section.

Account Settings

Country Filter:

A filter list enables users to refresh the data of the IAP by selecting a ‘Country’ option from a dropdown menu. A region filter refreshes data delivered to users by localising the content in the IAP interface. For example, users who wish to view only UK Websites can do so by clicking United Kingdom in the filter dropdown.

Change Classification Menu

Classifications

Once a user has customised their IAP, the classification menu options will be reflected within the Accounts setting/Classifications screen. From here users can add/remove classifications by checking/unchecking appropriate check boxes.

It is also worth remembering that the classifications can be regionally based. For example, some classifications may be more relevant in certain parts of the country than others. It is also contemplated that the server will recognise the location of the user and will offer the classification appropriate to that location or the user may need to inform the IAP of his/her new location so that the IAP can offer/download a library of deep links in classifications corresponding to the user's profile but appropriate to the user's new location. Alternatively, it can offer the user's own personal directory regardless of the user's geographical location. It is also possible that the directory will offer an indexable library of classifications, enabling the user to select various menus according to personal preferences at the time, such as journalist, money-saving tips and so on, and then to open up options within that class.

Updates & Upgrades to Software

The application will ping the IAP server on start up, and at regular predetermined intervals, in order to check whether or not a more up-to-date Affiliate Partner Data set is available to download. If it is determined that up-to-date data is Available on the server, the relevant updates are downloaded into the user's PC environment.

The IAPPCClient service on the server pulls all static partner data from the database every n minutes and stores this in an in-memory XML document. When a partner makes a change to its data through the IAP External Client these changes will be pulled from the database by the IAPPCClient after n minutes have passed and thus any clients calling getCustom will have the latest data in their IAP. The n minutes could be configured through the Internal Management System and this feature could be turned off if necessary. As regards software upgrades, users should be obliged to upgrade their software automatically. However, the process for installing upgrades should be seamless and transparent to the user, not requiring the user to double click a .MSI to upgrade.

A Typical Operating Sequence

Referring to FIG. 8, the IAP starts by registration (box 801) of a new user. Once successfully registered, the user's access to the IAP is customised (box 802). Here, the user enters personal data identifying such factors as age, gender, likes and dislikes, geographical location etc (as previously mentioned) to build up a user profile. This user profile remains with the user until such time as the user and the IAP provider agree changes. The user profile is portable between devices used by the user to access the system. As can be seen in FIG. 2, such devices may include PCs, notebooks and similar devices or truly portable devices such as mobile phones, PDAs etc, generally known as “thin client” devices. Having a single user profile enables a user to access the IAP from any device.

Once the user information has been gathered by the IAP provider, the IAP sets up the classifications appropriate to the user profile and downloads them onto the user device so that it can be cached locally for the user to carry out desired searches.

Once these preliminaries have been completed, the user can access the system (box 803) at any time and can thereby request access to deep links of his preselected choice, as previously described. However, before enabling connection to a partner website, the system first determines (box 804) whether the current partner data is up to date. If not, the process moves to box 805, where automatic update(s) are downloaded to the user device. After successful updating, as confirmed in box 804, the user can select (box 806) a desired classification and category, which causes the system to provide a deep link access (box 807) to a webpage.

All uses of the system to access webpages are recorded (box 808) for statistical purposes. Where a user successfully accesses a partner webpage (box 89), that use is logged, possibly by an intermediary and/or by the partner itself, and an entry made to a tracking and billing function (box 810), where the cost of access and possible commission is apportioned as previously contracted between the varies entities.

When the user has completed that particular access (whether or not it led to a purchase) the user can retreat from that particular access (box 811) and can either make a fresh selection (box 6 again) or can exit from the system (box 812).

The architecture that makes this process possible is outlined in FIG. 2. The IAP, represented at 213 in FIG. 2, provides service to a plurality of users, who may use devices such as PCs or notebooks, represented generically at 214, or thin client devices represented generically by the mobile phone 215.

The IAP contains databases respectively containing user data U and partner data P, which would be located in respective servers 216 and 217 within the IAP server hierarchy 224. Information relating to tracking and billing is provided to a tracking and billing function 218 which also receives partner data via a partner input 219. This enables various functions to be performed. For example, the provision of data from both the IAP and a Partner satisfies data protection legislation and enables charging to be logged for future reference, such as when a user visits a partner website but makes a purchase some time later but within a predetermined time window.

As part of the enhancements offered by the IAP, partner data from the input 219 is vetted by humans, as indicated at 220, so that only quality, trusted sites are included in the user classifications.

When data is to be downloaded to a PC 214, relevant partner data from a partner database 217 is merged 223 with user data from the user database 16 and transmitted down to the user at 214. However, when data from the user's device 214 is to be uploaded to the IAP server, partner and user data from the user's device 214 are demerged 223, as previously described, so that partner data is transmitted to the server separately from the user data. It is important to note that traffic is bidirectional as between the user, merge/demerge function and the user data U, whereas traffic can only flow from the partner data 217 to the merge/demerge function and the user.

A similar set-up is provided for mobile thin client devices 215 with the exception that the merge/demerge function 221 is associated with a compression function 222, which is preferably gzip, to match the device 215 bandwidth/speed capabilities.

General Points on the PC-Based Embodiment

In the same manner as deep links are made available to the user in a mobile telephone application, the PC user is also provided with a deep link search capability.

A dedicated Toolbar can be used for the A-Z indexing. However the other functions within the dedicated IAP UI are not available. Thus, when opening a shopping link, for example, this action alone may initiate opening up the IAP UI and/or an internet browser. The A-Z feature can be made available in any toolbar talking to a central database of links, such as partner links and user links. Alternatively, it can work both ways, i.e. within an open browser or an open IAP. In the case of a browser, it would automatically take the user to a website that the user selects.

The PC and mobile architectures differ in that they use standard toolboxes etc to create menus etc. In the case of a toolbar within Internet Explorer, implementation is extremely difficult, so it is preferable to use a toolbox to create the toolbar.

Site Recommendation Engine/Blogs

In addition to the above classifications, a specific blog page can be offered, which deals purely with users giving ratings to and comments on current and new possible websites. The application will be updated by the users eventually. This could extend to inviting users to rate existing websites on the partner database, and the introduction of new websites for the list, which then allows users to rate the new website so as to decide collectively whether it will be added or not. A blog facility will therefore let category content (websites and related deep links) to be modified.

Certain websites can be massive but they do not necessarily appear on the first few pages of a search using a search engine (such as Google) because of the way Google rates the websites. User ratings/opinions in the choice of searchable websites are unique to this invention, not least because no other sites offer a ratings assessed searchable directory of user favourites. In this way, the system can grow organically, which is consonant with predictions that social bookmarking is the future of the internet. This focusing of the user base is dedicated to improving the system and providing an objective (collective) assessment by users for the benefit of users. Simplicity will encourage use by new users of the internet.

The blog facility is provided by an IAP website ranking engine, which permits websites included within the IAP directory to be qualified via user reviews and recommendations. This functionality will enable a user (a) to review existing sites within the IAP directory on a qualitative basis and (b) to recommend sites currently not displayed within the directory. Both elements of the functionality allow users to rate and comment upon the sites in great depth via a web-based interface. The following rating criteria, along with free text comments, forms the basis of the review. Users will be able to enter their own rating of a website using a score for each of four criteria as follows:

Rating Criteria:

Popularity (how popular a site is)

Functionality (Accessibility, Speed, Navigation, Legality, Security)

Design (User friendliness, Aesthetics, Customer service)

Content (Purpose, information process).

Rating System:

0. Poor

1. Below Average

2. Average

3. Above Average

4. Good

5. Excellent

Each site is then given an overall score out of a total of 20, i.e. a maximum of 5 out of 5 per criterion. The average score will be taken from all user ratings and displayed as a percentage. Displaying this percentage score and free text comments will give the user an understanding as to the quality of each website.

The ranking system has also been applied to the software interface by pulling down ratings and comments from the IAP server. This allows users to view ratings on a per site basis and recommendations on a per category basis. The following example illustrates the process, based on features of the interface between the user and IAP.

The Ranking Interface Presents the Following:

Category, e.g.: DVD

Displaying the category shows the user the category in which the site they are reviewing falls.

Recent Reviews, e.g.: Amazon DVD

Recent reviews (recently reviewed websites) shows the user websites within their specified category that have been reviewed by other users

Website, e.g.: Tesco DVDs

This indicates the website that the user has chosen to review.

Current Rating, e.g.: 83%

Current rating shows the user the current average rating for that website based on other user reviews.

Your Rating, i.e.: Score Out of 5

This allows a user to score out of 5 based on each of the above criteria.

Comments, e.g.: “Your website is great!”

This allows the user to write a free text comment about the website in question.

The major advantage of the blog facility is that IAP content will be driven primarily by system users, quality will be regulated and coverage will be extended. Users therefore have an increased sense of ownership of the system.

Data Transfer

The IAP Partner Data is stored in a separate XML file on the client PC and is initialised or updated by requesting a transfer from the server database [getPartnerData] using the HTTP protocol, embedding the XML data compressed using the gzip format.

Partner Data is requested, transferred and stored separately on the Client PC file system on a country by country basis. Partner Data is only requested on initialisation or after having compared the timestamps to evaluate whether the server data is newer than the PC data. No session or login is required to request the Partner Data and the IAP UI does not need to be running. The HTTP embedded gzip has a custom protocol specified in the DTD attached, with some XML examples and notes.

A worked example of data transfer now follows, using the function name GetPartnerData.

Parameters:

String country: range of values returned in GetConstants ‘country’
String classification (optional): id of the classification
   Returns:
Partner XML conforming with the following DTD or error.
   Notes:
When the IAP client builds an HTTP query to the redir script, the following parameters are passed:
   link_id
   user_id
All users for the same country share the same partner data.
Menu visibility of classifications is stored in the GetUserData.
Partner links must be inside Partner folders.
Partner folders cannot contain user folders/links.
The classification id's are equal for all classifications countries. For example: “Business and Finance” in UK has the same id of “Business and Finance” in US. This enables the capability to merge user data in any country classification.

DTD:

| | |
|---|---|
| <!ELEMENT classifications (classification*)> | |
| <!ELEMENT classification (folder*, link*, banner*)> | |
| <!ELEMENT folder (folder*, link*, banner*)> | |
| <!ELEMENT link (banner*)> | |
| <!ELEMENT banner EMPTY> | |
| <!ATTLIST classifications baseredirurl CDATA #REQUIRED> | The baseredirurl points to the |
| | base url of the redirection script. |
| <!ATTLIST classification id CDATA #REQUIRED> | The classification identifier. |
| <!ATTLIST classification displayname CDATA #REQUIRED> | The classification string as is |
| | displayed in the UI. |
| <!ATTLIST classification imagename CDATA #REQUIRED> | The relative path as per the |
| | styles zip path, including name |
| | of the classification's image. |
| <!ATTLIST folder id CDATA #REQUIRED> | The id of the partner folder. |
| <!ATTLIST folder displayname CDATA #REQUIRED> | The folder string as is displayed |
| | in the categories tree panel. |
| <!ATTLIST folder type (category) CDATA #IMPLIED> | If the attribute “type” is not |
| | present, then the client will |
| | assume this as a standard partner |
| | folder. |
| <!ATTLIST folder imagename CDATA #IMPLIED> | If the attribute “imagename” is |
| | not present then the client will |
| | use the default folder image. |
| <!ATTLIST link id CDATA #REQUIRED> | The id of the partner link. |
| <!ATTLIST link displayname CDATA #REQUIRED> | The name of the link as is |
| | displayed in deep links. |
| <!ATTLIST link url CDATA #REQUIRED> | The alternate URL of the link to |
| | be used if the ZBDO server is |
| | not accessible. |
| <!ATTLIST link altsearchtext CDATA #IMPLIED> | An optional alternate search text |
| | to match searches in the A-Z |
| | box. |
| <!ATTLIST banner name CDATA #REQUIRED> | The name of the banner. |
| <!ATTLIST banner id CDATA #REQUIRED> | The identifier of the banner. |
| <!ATTLIST banner url CDATA #REQUIRED> | The target URL to show if user |
| | clicks a banner. |
| <!ATTLIST banner imageurl CDATA #REQUIRED> | URL of the animated banner to |
| | show. |

### EXAMPLE 1

<classifications baseredirurl=”http://www.contacts4life.com/iaptest/redir.dll”>
<classification id=″98591″ displayname=″Business*&amp; Finance″ imagename=”
images/icons/classifications/business_and_finance.png”>

<folder id=″98593″ displayname=″Category″ type=″category″>
<folder id=″11112″ displayname=″SubCategory″ type=″category″>

<banner name=″Intravisual″ id=″123485″ url=″http://www.intravisual.com″

imageurl=″http://www.contacts4life.com/banners/intravisuall.gif″ />

<folder id=″11111″ displayname=″Finance″ >
<folder id=″98594″ displayname=″Business″ >

| | |
|---|---|
| <link**id=″98595″ | displayname=″Business″ |

url=″http://news.bbc.co.uk/1/hi/business/″ />

<link id=″98596″ displayname=″Starting a business″

url=″http://www.businesslink.gov.uk/bdotg/action/layer?topicId=1073858805″ />

<link id=″98597″ displayname=″Accounts online″

url=″http://www.businesslink.gov.uk/bdotg/action/layer?r.l1=1073858805&r.s=m&topicId=1073858808
″ />

</folder>
<folder id=″98598″ displayname=″Records Management″ >

| | | |
|---|---|---|
| <link | id=″98599″ | displayname=″Info″ |

url=″http://www.recordsmanagement.ed.ac.uk/InfoStaff/DPstaff/ElectronicPersonalData.htm″ />

</folder>

</folder>

</folder>
</folder>

</classification>
</classifications>

### EXAMPLE 2

### Using Altsearchtext

<classifications baseredirurl=”http://www.contacts4life.com/iaptest/redir.dll”>
<classification id=″98591″ displayname=″Business &amp; Finance″>

<folder id=″98593″ displayname=″Category″ type=″category″>

<folder id=″11112″ displayname=″SubCategory″ type=″category″>

<folder id=″11111″ displayname=″Finance″ >

<folder id=″98594″ displayname=″Business″ open=”true”>

<link id=″98596″ altsearchtext=”Entrepreneur” displayname=″Starting a

business″ url=″http://www.businesslink.gov.uk/bdotg/action/layer?topicId=1073858805″ />

</folder>

</folder>

</folder>

</folder>

</classification>
</classifications>

The customised browsable directory provided by the invention utilises the capability of Internet Explorer to browse within itself. Technical constraints have previously prevented this kind of application being developed. In effect, a library of documents is stored with attributes relating to each user.

The search capability derives from the setting up of a tree of xml data, in which a parent and child relationship defines the nodes at which information can be stored. Therefore, when merging is being performed, the search string goes down the tree and looks for the required association, i.e. the child relates to its parent, and a comparison is made to the user's classification etc.

Some General Observations

The unique combination of benefits provided by the invention and open to the user includes any, some, or all of the following:
Personalisation
vetting of sites by human intervention
potential money savings for the user
special deals classification (with two ways of going to the data—
either directly through the website link or through the special deals class)
flags on data showing whether the website has a special offer.

In summary, in certain embodiments, the invention relates to a method, a system, a set of computer-readable instructions, a signal and a programmed computer are described enabling a user to go directly to a predetermined webpage of an internet website without having to navigate from the home page of that website. A structured directory of deep links is created, the deep links grouped according to a plurality of predetermined classifications provided by the service provider according to a user profile, each deep link representing an address of a predetermined webpage within a website corresponding to at least one of the predetermined categories. The directory is stored locally to the user, e.g. in a PC or mobile handset. The user simply selects a desired classification/category then a deep link within that category and activates the link to access directly the predetermined page. The webpages are monitored by humans to ensure they meet quality criteria. Updating is effected from a remote server. Links to partner websites offering special deals may be placed in a dedicated category. The system provides a facility for tracking and billing usage. A ratings assessment blog facility is provided, driven by user inputs, to provide objective quality ratings to both existing and newly recommended websites and deep links.

It is of course to be understood that the invention is not intended to be restricted to the details of the above embodiments which are described by way of example only.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A method for providing direct access to a webpage of an internet website, the method comprising:
creating a structured directory of deep links, the deep links grouped according to a plurality of predetermined categories, each deep link representing an address of a specific webpage within a website corresponding to at least one of said predetermined categories;
whereby a user can select a deep link from a chosen category and can activate said selected deep link to gain direct access to the webpage directly without navigating through the website from a home page to the webpage.

2. A method according to claim 1 wherein said predetermined categories are dependent from wider classifications.

3. A method according to claim 1 further comprising storing said directory in said memory as a searchable tree structure in which data is stored on the basis of a linked parent/child relationship.

4. A method according to claim 1 wherein said predetermined categories constitute a menu style directory.

5. A method according to claim 1 wherein said predetermined categories are selected from a larger collection of such categories.

6. A method according to claim 5 wherein only said predetermined categories are displayed.

7. A method according to claim 5 wherein said larger collection of such categories is displayed.

8. A method according to claim 1 wherein a dedicated category is created for internet search engines.

9. A method according to claim 1 wherein said structured directory is searchable.

10. A method according to claim 9 wherein said structured directory is searchable alphanumerically.

11. A method according to claim 9 wherein a user can search on a look ahead basis.

12. A method according to claim 9 wherein when searching the top match is auto rendered within a display pane.

13. A method according to claim 1 wherein said structured directory is visible at the same time and on the same display as a preview pane.

14. A method according to claim 13 wherein a plurality of preview panes are displayed.

15. A method according to claim 13 wherein the or each preview pane displays a selected deep link.

16. A method according to claim 13 wherein the or each preview pane displays a webmail application.

17. A method according to any of claims 13 wherein the or each preview pane displays current affairs information.

18. A method according to any of claims 13 wherein the preview pane displays a VOIP application.

19. A method according to claim 1 wherein a single user click enables access to said deep link.

20. A method according to claim 19 wherein the single user click enables such access from within any such predetermined category.

21. A method according to claim 1 further comprising modifying said directory of deep links via user input.

22. A method according to claim 21 wherein in said modifying the user adds a favourite deep link.

23. A method according to claim 21 wherein in said modifying the user deletes an existing user defined deep link.

24. A method according to claim 21 wherein in said modifying the user hides an existing deep link.

25. A method according to claim 1 wherein said predetermined categories are tailored to an individual user in dependence on user personal information.

26. A method according to claim 25 wherein such user personal information is at least one of age, gender, location and special interests.

27. A method according to claim 1 wherein a “Favourites” list from an internet browser is imported into said structured directory of deep links.

28. A method according to claim 1 wherein said structured directory is searchable via a dedicated toolbar in an internet browser.

29. A method according to claim 1 wherein said structured directory of deep links is displayed as a menu within an internet browser.

30. A method according to claim 1 further comprising displaying a home page from which said structured directory is accessed.

31. A method according to claim 30 wherein the home page is tailored according to user preference.

32. A method according to claim 1 wherein the deep links are vetted with human intervention.

33. A method according to claim 1 wherein the deep links are updated with human intervention.

34. A method according to claim 1, further comprising:
providing a dedicated category containing a dedicated deep link to at least one predetermined page of a predetermined partner website offering special services, whereby activation of said dedicated deep link directly accesses predetermined special services in predetermined pages other than a home page of said partner website.

35. A method according to claim 1, further comprising:
providing a dedicated category containing a dedicated link to a private home page of a predetermined partner website offering special services, whereby activation of said dedicated link directly accesses said private home page of said predetermined partner website; and
navigating to at least one webpage within the partner website other than the private home page within the partner website, said private home page only being accessible to a user via the dedicated link.

36. A method according to claim 1, wherein said deep links have an identifier to determine whether they can be viewed on a personal computer or a mobile device or both.

37. A device for providing direct access to a webpage of an internet website, the device comprising:
a structured directory of deep links, the deep links grouped according to a plurality of predetermined categories, each deep link representing an address of a specific webpage within a website corresponding to at least one of said predetermined categories;
a selector to select a deep link from a chosen category and activating said selected deep link to gain direct access to the webpage directly without navigating through the website from a home page to the webpage.

38. A server providing direct access to a webpage of an internet website, the server comprising a structured directory of deep links, the deep links grouped according to a plurality of predetermined categories, each deep link representing an address of a specific webpage within a website corresponding to at least one of said predetermined categories.

39. A computer readable storage medium comprising a set of instructions for providing direct access to a webpage of an internet website, the instructions comprising:
code enabling a structured directory of deep links, the deep links grouped according to a plurality of predetermined categories, each deep link representing an address of a specific webpage within a website corresponding to at least one of said predetermined categories; and
code enabling the user to select a deep link from a chosen category and activate said selected deep link to gain direct access to the webpage directly without navigating through the website from a home page to the webpage.

40. A server to provide direct access to a webpage of an internet website, the server comprising:
means for creating a structured directory of deep links, the deep links grouped according to a plurality of predetermined categories, each deep link representing an address of a specific webpage within a website corresponding to at least one of said predetermined categories;
whereby a user can select a deep link from a chosen category and can activate said selected deep link to gain direct access to the webpage directly without navigating through the website from a home page to the webpage.
